(19) United States
(12) Patent Application Publication
(10) Pub. No.: US 2017/0116369 A1
(43) Pub. Date: Apr. 27, 2017

(54) METHOD FOR DESIGNING OVERALL STOICHIOMETRIC CONVERSIONS AND INTERVENING METABOLIC REACTIONS

(71) Applicant: THE PENN STATE RESEARCH FOUNDATION, University Park, PA (US)

(72) Inventors: Anupam Chowdhury, University Park, PA (US); Costas D. Maranas, University Park, PA (US)

(21) Appl. No.: 15/146,602

(22) Filed: May 4, 2016

Related U.S. Application Data
(60) Provisional application No. 62/156,978, filed on May 5, 2015.

(51) Int. Cl. G06F 19/12; G06F 17/11

(52) U.S. Cl. CPC G06F 19/12; G06F 17/11

(57) ABSTRACT

The present invention describes a two-step computational procedure that both identifies the optimum overall stoichiometry of conversion, along with alternate co-reactant (or co-product) combinations, of a feedstock substrate to a biochemical product, and selects for (non-)native reactions accessed from a universal database to identify at least one stoichiometry-balanced minimal metabolic network, in terms of number of reactions or sum of the flux in the network, that maximize carbon or energy efficiency while satisfying thermodynamic feasibility requirements. A representation of the overall stoichiometry of conversion and the minimal metabolic network as designed can be stored.

### CROSS-REFERENCE TO RELATED APPLICATIONS

This application claims priority under 35 U.S.C. §119 to provisional application Ser. No. 62/156,978, filed on May 5, 2015, herein incorporated by reference in its entirety.

### GRANT REFERENCE

This invention was made with government support under Grant No. DE-SC0008091, awarded by the Department of Energy and under Grant No. EEC0813570, awarded by the National Science Foundation. The Government has certain rights in the invention.

### BACKGROUND OF THE INVENTION

The present invention relates to a computational framework that identifies the optimum overall stoichiometry and selects for (non-)native metabolic reactions for optimizing the converting source metabolite(s) and target product(s).

Microbial metabolism describes the full range of enzymatic conversions of carbon substrates to cellular biomass precursors, energy equivalents and biochemical molecules. Metabolic engineering harnesses this metabolic machinery for converting feedstock substrates to a growing range of products [1-3]. Recent advances in multiplex engineering (e.g., MAGE [4]), efficient genome-editing (e.g., CRISPR-Cas [5,6]) and genome-wide regulation of gene expression through small RNAs [7] have brought closer the dream of “designer cells” that can catalyze any tailor-made stoichiometry-balanced metabolic conversion with high specificity and control [8].

Existing computational procedures for the de novo pathway design rely on either optimization techniques or graph-search approaches. Linear Programming (LP) and Mixed Integer Linear Programming (MILP) approaches for pathway design, in general, extract a minimal, stoichiometry-balanced sub-network that converts a source metabolite to a target chemical with high yield [9]. While early work was restricted to design pathways for small-to-medium size networks [10-12], recent procedures have reached up to genome-scale size [13-15] often using the concept of elementary modes [16] and comprehensive databases of reactions [17-20]. Generally, pathways are identified that maximize product yield given a single carbon substrate [21] without considering co-substrates, co-products, or complex overall stoichiometries.

Graph-based pathway design approaches [22] begin from the target chemical and iteratively retrace back a path to the source metabolite using a retrosynthetic algorithm. Using a depth-first search, variations of the k-shortest path approach have been used to design and classify pathways based on their length [23], negativity of free energy of change for each reaction step [24], or use of intermediate metabolites with the fewest connections [25]. Graph-search approaches can be supplemented with “reaction-rules” that can suggest de novo reaction steps between any two metabolites often absent in existing databases (e.g., BNICE [26], XTMS [27], GEM-Path [28]). In most cases, the consumption (or production) of cofactors and possibly co-reactants or co-products required for these pathways to operate is not directly tracked [29]. As a result, these procedures are often coupled with a post-processing step where a Flux Balance Analysis (FBA) is performed to select pathways that are stoichiometry-balanced and maximize the production of target chemicals. As with LP or MILP based approaches, generally mostly linear pathway topologies are traced.

Powerful as these approaches have been, their primary shortcoming lies in the fact that they aim to trace pathways connecting a single substrate (A) to a single product (B). Metabolic conversions do not generally involve linear paths from substrate to product [21]. Most metabolic engineering tasks recruit many more metabolites and reactions than the ones along the main carbon conversion path. Cofactor usage, co-reactant choices as well as stoichiometric ratios are important decision variables during the pathway design stage. It is the overall stoichiometry that globally captures the overall goal rather than just the origin and destination molecules. This overall stoichiometry can interact in complex ways with the rest of the metabolites forming highly non-intuitive networks constrained by thermodynamics.

The primary object, feature or advantage of the present invention is the development of a stoichiometry and pathway design tool that optimizes the overall stoichiometry (e.g., aA+cC→bB+dD) by exploring exhaustively co-reactant/co-product combinations. The coefficients in the overall stoichiometry (i.e., a, b, c and a) are critical as they ultimately define the carbon and energy efficiency of the conversion while meeting thermodynamic feasibility.

Yet another object, feature and advantage of the present invention is to directly include economic considerations implied by the prices or reactant and product molecules in the optimization formulation for designing the overall stoichiometry.

A further object, feature and advantage of the present invention is to identify intervening reactions from a universal database that link the chosen reactants and products in the stoichiometric ratios as guided by the overall stoichiometry of conversion.

Yet another object, feature and advantage of the present invention is that requirements on the minimality of size of the network and negativity of the free energy of change of each individual reaction step can also be imposed to help rank-order all identified designs. One or more of these and/or other objects, features and advantages of the present invention will become apparent after review of the following detailed description of the disclosed embodiments and appended claims. No single embodiment need exhibit all of these objects, features, or advantages. It is contemplated that different embodiments may have different objects, features, or advantages.

### SUMMARY OF THE INVENTION

The present invention provides a computational framework for designing optimum overall stoichiometry, and intermediate metabolic reaction steps of achieving the conversion between a source and target metabolite with alternate co-reactants/co-products combination. The source and target metabolites, and the combination of co-reactants/co-products are selected from a universal database, and may range from electron acceptor pairs such as iron(III)/iron(II) driving the oxidation of methane to liquid biofuels, to platform biochemicals such as 2,3-butanediol and 3-hydroxypropionate. Likewise, the set of intermediate biotransformations is selected from a curated database with over 6000 reactions. Combinatorial optimization is employed in the first step to identify the stoichiometric coefficients of the reactant and product metabolites in the overall conversion while maintaining thermodynamic feasibility considerations. In general, the optimization objective is to identify an overall conversion that maximally utilizes a limiting carbon resource towards a target product, while alternate fitness functions such as maximizing the difference between the prices of the target products and the cost of the reactants can also be explored. Participating metabolites could be known a priori or sourced from the database of metabolites. The second step searches through the universal database of elementally and charged balanced reactions to extract a (generally minimal) set of reactions that conform to the identified overall conversion stoichiometry identified under the first step. Additional constraints, such as minimality of reactions with positive Gibbs free energy change and minimizing the number of heterologous reactions in the optimal network can be included in the optimal formulation. The present invention was implemented for three separate case studies of increasing complexity. The first one exhaustively identifies networks that convert glucose to acetate while conserving all carbon atoms with no provision for any additional co-reactants or co-products in the spirit of the recent study by Bogorad and co-workers [30]. The second study, explores the combined use of methanol and carbon dioxide for the production of stoichiometry-feasible C₂₊ products. The third study, aims at designing thermodynamically feasible overall stoichiometries for fixing methane to acetate and other C₂₊ co-products. The two-stage procedure recapitulates existing pathway designs [31-34] and identifies novel pathway topologies inaccessible to existing algorithms. Overall conversion stoichiometries and pathway designs span a range of complex network topologies and provide valuable insight as to how the overall conversion pathway changes in response to alternate co-reactant and/or co-product scenarios.

According to one aspect, a computational method of designing de novo metabolic networks includes the steps of determining the overall stoichiometry of conversion for converting source metabolite(s) to the target product(s) by exhaustively exploring co-reactant/co-product combinations and their respective stoichiometric coefficients and identifying an optimal network of intervening metabolites and reactions from a database that link the chosen reactants and products in the desired stoichiometric ratios.

### BRIEF DESCRIPTION OF THE DRAWINGS

FIG. 1 describes the framework of the two-step (optStoic+minRxn/minFlux) overall stoichiometry and network path-design method. Step 1 (optStoic) identifies the overall stoichiometry of conversion from A to B maximizing a desired performance objective subject to overall constraints of elemental and charge balance and thermodynamic feasibility. Step 2 identifies a network of reactions (in red) from a reaction database that meet the overall stoichiometry from Step 1 by either minimizing the number of reactions (minRxn) or the total metabolic flux (minFlux), subject to constraints of stoichiometric balance and reaction directionality. Additional constraints exploring alternate overall reaction stoichiometry (in Step 1) and network designs (in Step 2) are also shown.

FIG. 2 describes six alternate networks for conversion of glucose to acetate with 100% carbon efficiency. The abbreviations for reaction names are in upper case with their corresponding flux values in italics.

FIG. 3 describes three network designs for the utilization of methanol and carbon dioxide towards acetate. The fluxes of the corresponding reactions are shown in italics below the reaction name.

FIG. 4 describes network designs for the utilization of methanol and carbon dioxide towards (A) 3-hydroxybutyrate (B) 2-ketoisovalerate and (C) aromatic phloroglucinol.

FIG. 5 describes three network designs for fixing methane and carbon dioxide towards acetate using Fe³⁺/Fe²⁺ electron acceptor pair.

FIG. 6 describes network designs for conversion of methane and C₁ co-reactant towards four C₂₊ target chemicals.

### DETAILED DESCRIPTION OF THE PREFERRED EMBODIMENTS

The present invention provides a computational framework that identifies the optimum overall stoichiometry and selects for (non-)native metabolic reactions for optimizing the converting source metabolite(s) and target product(s). Preferably the methods are computer implemented or computer assisted or otherwise automated. The term “computational” as used herein should be construed broadly to include, but not to be limited to, any number of electronic devices suitable for practicing the methodology described herein. It is further to be understood that because the invention relates to computer-assisted modeling that the scope of the invention is broader than the specific embodiments provided herein and that one skilled in the art would understand how to apply the present invention in different environments and contexts to address different problems in part due to the predictability associated with computer implementations. Where the methods are computer implemented in part, it is to be understood that instructions for performing the methods may be stored in whole or in part on computer readable non-transitory medium and the instructions may be executed on or by a computing device. Similarly, data may be stored in whole or in part on a computer readable non-transitory medium.

Despite enormous progress over the past few years, available pathway-design procedures generally are restricted to only (near) linear routes from the source (or metabolite in the host metabolome) to the target metabolite. Linear pathway designs miss cyclic networks with potential for higher efficiency (both carbon and energy) of production (e.g., 100% carbon efficiency in conversion of glucose to acetyl-CoA [30]). In addition, by restricting the degrees of freedom to just the source and target metabolite, the identification of alternative co-reactants/co-products combinations are ignored. While post-processing efforts restore stoichiometry-balance of pathways [28], this may lead to designs with suboptimal carbon and energy efficiencies.

The present invention formulates a two-step computational procedure (optStoic+minRxn/minFlux) for designing de novo networks that match an overall stoichiometry of chemical transformation. Performance criteria on the designed pathways (e.g., carbon yield/energy efficiency, pathway ΔG etc.) can systematically be imposed and rank-order synthetic pathways according to the design objective. Implementation for of this invention in three pathway design studies identified non-intuitive designs with improved efficiencies. Specifically, multiple alternatives for non-oxidative glycolysis are generated and non-intuitive ways of co-utilizing carbon dioxide with methanol are revealed for the production of C₂₊ metabolites with higher carbon efficiency. Likewise, several non-intuitive solutions were identified for driving forward the thermodynamically unfavorable conversion of methane to acetate and other C₂₊ metabolites.

### 1.1 Material and Methods

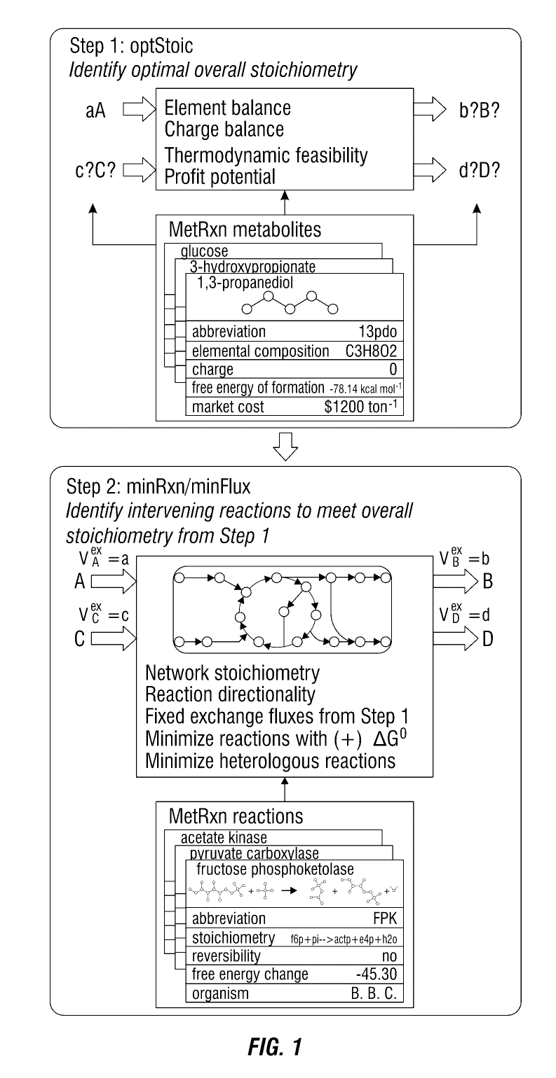

The optimization procedure is divided in two steps (see FIG. 1). The first step identifies the stoichiometric coefficients of the reactant and product metabolites in the overall conversion while maintaining thermodynamic feasibility considerations. The second step, searches through a database of elementally and charged balanced reactions to extract a (generally minimal) set of reactions that conform to the identified overall conversion stoichiometry identified under the first step. The following section describes each step in detail.

### Step 1: Determining Optimal Reactant and Product Combination and Overall Stoichiometry

The procedure begins with an optimization task that establishes the maximum achievable yields of the envisioned bioconversion subject to thermodynamic restrictions. At this stage, not just the overall conversion stoichiometry but also some of the co-reactants and/or byproducts are yet to be determined. Generally, the goal during this scoping phase is to identify an overall conversion that maximally utilizes a limiting carbon resource towards a target product while the intervening reaction steps are left at this stage unexplored. Ancillary considerations may include (i) co-utilization of other carbon substrates (e.g., gaseous reactants), (ii) possible co-production of valuable by-products, (iii) co-generation of redox resources for biomass, etc. Both the identity of some of the reactants and products as well as the overall stoichiometry are degrees of freedom that can be optimized towards meeting the above stated performance objectives.

This optimization task requires access to a database of metabolites along with specific data for each one of them. In this paper we assembled a database of 5,753 metabolites extracted from the MetRxn database [35] (see Supplementary File 51). The following parameters are introduced that keep track of the elemental composition, charge information and free energy of formation data needed to describe the optimization problem:
n_{iq}: # of atoms of element q in metabolite i
eᵢ: charge of metabolite i [36]
   ΔGᵢ^{f}: Transformed free energy of formation (at 25° C. and 0.1M ionic strength) of metabolite i [37] where i=1, . . . , N is the set I of metabolites present in the database and qεQ is the set of elements found in the metabolites (i.e., C, O, N, P, S, H, Fe, etc.) (see Supplementary File S1 for dataset).

For the sake of simplicity of presentation the optimization formulation is derived for the following bimolecular stoichiometry as shown in FIG. 1:

aA+cC→>bB+dD

Using this representation either all the metabolites participating in the reaction are known a priori implying that all coefficients are positive and non-zero or the presence of some of them is uncertain in which case the corresponding stoichiometric coefficients are allowed to assume a value of zero. Obviously, the list of reactants and products does not have to be restricted to two. More complex overall stoichiometries can be put forth with positive coefficients denoting products and negative reactants. Only one of the stoichiometric coefficients needs to be fixed to a finite value to provide a scaling for the remaining ones. Generally, we fix either the coefficient of the limiting carbon substrate or the primary product. By fixing this coefficient the presence of the corresponding reactant or product in the overall conversion is guaranteed. Note that setting the stoichiometric coefficient of a one-carbon molecule to one may not ensure that all other coefficients can assume integer values due to the balances on all other elements. However, all determined coefficients could be suitably scaled up to obtain an integer-only stoichiometry for all metabolites. The performance criteria of the overall conversion may involve (i) maximum yield for primary product B (i.e. max b while a=fixed), (ii) maximum co-utilization of free reactant C (max c, b=fixed) for a given product yield, (iii) minimum formation of by-product D (min d while b=fixed) or combinations thereof. The overall optimization formulation for Step 1 is as follows (optStoic):

$${Maximize}_{( a , b , c , d )} f ( a , b , c , d ) ( optStoic )$$

$$subject to$$

$$\begin{matrix}{n}_{Bq} b + {n}_{Dq} d - {n}_{Aq} a - {n}_{Cq} c = 0 , ∀ q ∈ Q & ( 1 ) \\ {e}_{B} b + {e}_{D} d - {e}_{A} a - {e}_{C} c = 0 , & ( 2 ) \\ Δ {G}_{B}^{f} b + Δ {G}_{D}^{f} d - Δ {G}_{A}^{f} a - Δ {G}_{C}^{f} c \leq - Δ {G}^{min} , & ( 3 ) \\ h ( a , b , c , d ) = 1 , \\ a , b , c , d ∈ {ℛ}^{+} \text{/} Z & ( 4 )\end{matrix}$$

In formulation (optStoic), f (a,b,c,d) is a function of the overall stoichiometric coefficients quantifying a performance objective, Constraint (1) and (2) impose elemental and charge balances on the overall conversion respectively, while Constraint (3) imposes overall thermodynamic feasibility (ΔG^{overall}<0). ΔG^{min} quantifies the amount of “extra” ΔG available for the designed stoichiometry. The stoichiometry of the basis metabolite (usually the limiting carbon source) is set to a value of one. Constraint 4 generalizes the description of this scaling decision. Stoichiometric coefficients a,b,c,d can be declared as integer or real depending on the adopted scaling of the overall conversion. It is straightforward, to extend the optStoic formulation to account for more than two reactants and two products. In fact, a comprehensive list of putative co-reactants and co-products could be designed in the overall stoichiometry and then rely on the optStoic optimization problem to identify the optimal combination of co-reactants and co-products. A negative value for a stoichiometric coefficient declares a metabolite as a reactant while a positive value defines it as a product. Reactants or products with an inferred zero stoichiometric coefficient in essence “drop out” from the imposed overall stoichiometry.

The impact of cellular growth requirements on the flux allocation towards the target metabolite can be directly assessed by updating the overall stoichiometry to include biomass, growth (and non-growth) associated maintenance ATP as additional product metabolites:

$$aA + cC \to bB + dD + δ {\sum }_{k ekem K} {coeff}_{k} {M}_{k}$$

Here positive variable δ is the cellular growth coefficient, and biomass is represented as a weighted (by coeffₖ) sum of all the biomass precursors Mₖ (i.e., amino acids, lipids, cofactors as well as ATP requirements for cellular growth). Constraints for elemental and charge balances, and thermodynamic feasibility limitations are updated accordingly in optStoic:

$${n}_{Bq} b + {n}_{Dq} d + δ {\sum }_{k ∈ K} {n}_{kq} {coeff}_{k} - {n}_{Aq} a - {n}_{Cq} c = 0 , q ∈ Q$$

$${e}_{B} b + {e}_{D} d + δ {\sum }_{k ∈ K} {e}_{k} {coeff}_{k} - {e}_{A} a - {e}_{C} c = 0 , \\ Δ {G}_{B}^{f} b + Δ {G}_{D}^{f} d + δ {\sum }_{k ∈ K} Δ {G}_{k}^{f} {coeff}_{k} - Δ {G}_{A}^{f} a - Δ {G}_{C}^{f} c = 0$$

The trade-off between product yield and biomass formation can be assessed by fixing δ at different levels between zero and maximum growth and subsequently maximizing the target product coefficient.

Profit margin considerations (e.g., by using bulk market price of chemicals [38]) can be directly imposed in the optStoic formulation by specifying that the product prices exceed the reactant costs by a pre-specified margin profit^{min}.

pr_{B}b+pr_{D}d−pr_{A}a−pr_{C}c≧profit^{min}

where prᵢ are the per mole prices of reactants and products i. Alternatively this margin could become the objective function that is maximized if an economic criterion is used to select reactant/product pairs. Trade-offs between the overall conversion stoichiometry and the negativity of the overall free energy of change can be drawn by varying the value of ΔG^{min}. For large values of ΔG^{min} overall conversions are obtained with a high thermodynamic driving force. As ΔG^{overall} is throttled back closer to zero more yield efficient conversions are obtained at the expense of a lower thermodynamic driving force that may limit flux per enzyme loading. Given that biomass formation is an endergonic process (ΔG>0) it is important to keep ΔG^{min} above the value needed for the desired growth. For example, for the iAF1260 metabolic model we find that the production of all constituents of biomass require a ΔG of 492.77 kcal g⁻¹ biomass. Additional reserves for ΔG are needed to account for polymerization free energy costs of the biomass precursors not captured in the biomass equation. Alternatively, the overall stoichiometry could be expanded to directly include biomass, growth and non-growth associated maintenance ATP as product metabolites as described above.
Step 2: Identifying Reactions that Conform to the Identified Overall Stoichiometry

The second step identifies the smallest network of reactions that apportions the elemental composition of the substrates to the desired products in their corresponding stoichiometric ratios as determined in Step 1 (see FIG. 1). To this end we extracted a set of mass and charge balanced reactions J (i e, 6,302 reactions) from the MetRxn database [35] involving metabolites from set I (see Supplementary material 51 for datasets). In addition, exchange reactions for only the metabolites present in the overall stoichiometry are added to allow for their uptake and export, respectively. Therefore, all flux from the reactant metabolites is routed directly or recycled through intermediates towards the target metabolites. The optimization formulation for identifying the minimal number of reaction to match the identified stoichiometry requires the definition of the following parameters:

Sᵢⱼ: Stoichiometry matrix that describes the coefficient of metabolite i in reaction j (see Supplementary File S3 for dataset)
ΔGⱼ^{LB}, ΔGⱼ^{UB}: Lower and upper bound estimates for the ΔG of each reaction (see Supplementary File S4 for dataset)
LBⱼ, UBⱼ: Lower and upper bounds on the flux of each reaction j

The change in free energy ΔG of a reaction is a function of the non-standard activities of the participating metabolites as follows:

ΔGⱼ=ΔGⱼ⁰+RT ln Qⱼ, ∀jεJ

where R is the gas constant and T is the temperature. ΔGⱼ⁰ is the free-energy change of the reaction under standard conditions. Note that Q is the reaction quotient expressed as the ratio of the product of the activities (approximated by their molar concentration in an aqueous solution) of the products raised to their stoichiometric coefficient to that of the reactants. The reaction quotient Q for the overall conversion a A+c C→b B+dD is:

$$Q = \frac{{{[ B ]}^{b} [ D ]}^{d}}{{{[ A ]}^{a} [ C ]}^{c}}$$

where the expressions within brackets are the molar concentrations of each participating metabolite. The minimum (ΔGⱼ^{LB}) and maximum (ΔGⱼ^{UB}) bounds on the ΔG for each reaction in J are obtained by varying the concentration of the metabolites participating in the reaction by 1,000 fold of their transformed standard concentration (see Supplementary File S5). The wide range was chosen as a conservative estimate to allow for extreme fluctuations in intracellular metabolite concentrations in microorganisms (e.g., Bennet and co-workers [39] reported intracellular metabolite ranges in exponentially growing E. coli to vary between 10⁻³-10² mM). Reaction bounds LBⱼ and UBⱼ are determined according to the following rule:

$${LB}_{j} = \{ \begin{matrix}0 , if Δ {G}_{j}^{UB} < 0 \\ - M , if Δ {G}_{j}^{UB} > 0\end{matrix} \\ {UB}_{j} = \{ \begin{matrix}M , if Δ {G}_{j}^{LB} < 0 \\ 0 , if Δ {G}_{j}^{LB} > 0 \end{matrix}$$

where M is a large positive value (i.e., M=1,000) in relation the exchange flux of the metabolites of the overall stoichiometry (from Step 1). Additional information on directionality of reactions obtained from literature can be used, whenever available, to further constraint LBⱼ and UBⱼ. The directionality for 4,447 reactions (out of 6,302 within set J) was assigned by this procedure while the remaining 1,855 that lacked the free energy of formation for one or more metabolite were treated as reversible. Out of the 4,447 analyzed reactions, 2,205 were found to be irreversible whereas 2,242 were reversible. The identification of the minimal set of reactions that can match the desired overall stoichiometry (found after Step 1) is formulated as the following MILP (minRxn) problem:

$$\begin{matrix}{Minimize}_{( {y}_{j} )} {\sum }_{j ∈ J} {y}_{j} ( minRxn ) \\ subject to & ( 5 ) \\ {\sum }_{j ∈ J} {S}_{ij} {v}_{j} = 0 , ∀ i ∈ I & ( 6 ) \\ \begin{matrix}{v}_{A}^{ex} = - a , {v}_{C}^{ex} = - c \\ {v}_{B}^{ex} = b , {v}_{D}^{ex} = d \end{matrix} ] & ( 7 ) \\ {LB}_{j} {y}_{j} \leq {v}_{j} \leq {UB}_{j} {y}_{j} , ∀ j ∈ J \\ {v}_{j} ∈ ; {y}_{j} ∈ \{ 0 , 1 \} & ( 8 )\end{matrix}$$

Binary variables yⱼ defined as

$${y}_{j} = \{ \begin{matrix}1 , if {LB}_{j} \leq {v}_{j} \leq {UB}_{j} \\ 0 , if {v}_{j} = 0 \end{matrix}$$

control the addition (or not) of reaction j in the overall network. The objective function involves the minimization of the sum of yⱼ's (Constraint 5) to extract the minimum number of reactions that can support the desired overall stoichiometry (optStoic) of Step 1. Constraint (6) ensures that all metabolites, including cofactors, are used in a stoichiometrically balanced manner. Constraint (7) sets the flux of the exchange reactions (i.e., for A, B, C and D) equal to their respective stoichiometric coefficients thus matching the overall desired stoichiometry (from Step 1) and providing a flux scaling. Constraint (8) ensures that reaction j is removed from the designed network when yⱼ is equal to zero. Networks for different overall stoichiometries (from Step 1) can be obtained and contrasted for their overall performance metrics. The use of integer cut constraints to (i) disallow previously identified solutions and (ii) search for alternate optimal as well as sub-optimal solutions can be used to exhaustively explore all possible ways of linking reactants to products (Constraint 9).

$${\sum }_{j \vert {y}_{j}^{k} = 0} {y}_{j} + {\sum }_{j \vert {y}_{j}^{k} = 1} ( 1 - {y}_{j} ) 1 \geq , ∀ k = 1 , … , K \qquad ( 9 )$$

where k=1, . . . , K is the set of previously of explored solutions.

The resulting (minRxn) MILP formulation can be computationally challenging to solve as it involves as many as 6,302 binary variables associated with all the reactions in set J. A related LP formulation (minFlux) that is significantly (i.e., up to three orders of magnitude) less computationally taxing can be solved as a surrogate of minRxn. In contrast to minRxn that directly minimizes the total number of reactions in the designed network, minFlux minimizes the total metabolic flux of the chosen reactions. This modified objective function could be viewed as an approximation of the total enzyme-load imposed on the organism [40]:

$$\begin{matrix}{Minimize}_{( {x}_{j} )} {\sum }_{j ∈ J} {x}_{j} ( minFlux ) \\ subject to & ( 10 ) \\ {\sum }_{j ∈ J} {S}_{ij} {v}_{j} = 0 , ∀ i ∈ I & ( 6 ) \\ \begin{matrix}{v}_{A}^{ex} = - a , {v}_{C}^{ex} = - c \\ {v}_{B}^{ex} = b , {v}_{D}^{ex} = d \end{matrix} ] & ( 7 ) \\ {LB}_{j} \leq {v}_{j} \leq {UB}_{j} , ∀ j ∈ J & ( 11 ) \\ {x}_{j} \geq {v}_{j} , ∀ j ∈ J & ( 12 ) \\ {x}_{j} \geq - {v}_{j} , ∀ j ∈ J \\ {v}_{j} , {x}_{j} ∈ & ( 13 )\end{matrix}$$

In minFlux, the sum of the absolute values of the reaction fluxes denoted by xⱼ is minimized (Constraint 10). Constraints (6) and (7) are the same as in (minRxn) formulation whereas Constraint (11) imposes bounds on fluxes without multiplication with a binary variable. Constraints (12) and (13) ensure that xⱼ is greater than both vⱼ and −vⱼ. The minimization operator in the objective function ensures that for every j either Constraint (12) or (13) becomes active.

Alternate optimal (as well as suboptimal) basic flux combinations can also be explored by preventing all nonzero basic variables from an earlier solution k from reappearing in subsequent flux combinations (see Lee and co-workers [41] for details). In short, we first reorganize minFlux in standard form [42] and transform all the variables (i.e., xⱼ and vⱼ) to positive variable sₗ (where L is the set of variables for problem in standard form). Subsequently, a set of integer cut constraints similar to the ones described for formulation (minRxn) can be constructed. Binary variables uₗ denote the presence of nonzero basic variable l in a previously identified solution k. The following constraints prevents the reappearance of a previously found basic feasible solution:

$$\begin{matrix}ɛ {u}_{l} \leq {s}_{l} \leq {Mu}_{l} , ∀ l ∈ L & ( 14 ) \\ {\sum }_{l \vert {u}_{l}^{k} = 1} ( 1 - {u}_{l} ) \geq 1 , ∀ k = 1 , … , K & ( 15 )\end{matrix}$$

where ε is a small positive value (ε=10⁻⁵) that ensures that sₗ is nonzero when uₚ=1. It is important to stress that the addition of integer cuts converts the LP (minFlux) formulation to an MILP problem. Nevertheless, it is can be solved significantly faster (about two orders of magnitude) than minRxn as it involves much fewer binary variables.

Additional constraints can be added in either minRxn or minFlux optimization formulations to maintain the total number of reactions with a positive standard free energy of change at a minimum (e.g., less than p^{t}):

$$\begin{matrix}{v}_{j} \geq {LB}_{j} {u}_{j} , ∀ j \vert Δ {G}_{j}^{0} \leq 0 & ( 16 ) \\ {v}_{j} \leq {UB}_{j} {u}_{j} , ∀ j \vert Δ {G}_{j}^{0} \geq 0 & ( 17 ) \\ {\sum }_{j} {u}_{j} \leq {p}^{′} & ( 18 )\end{matrix}$$

where uⱼ is a binary variable which is defined as:

$${u}_{j} = \{ \begin{matrix}1 , if sign ( {v}_{j} ) = sign ( Δ {G}_{j}^{0} ) \\ 0 , otherwise \end{matrix}$$

Reactions with a positive standard free energy of change may require the accumulation of a significant reactant metabolite pool to drive the reaction forward. This is generally undesirable as it may throttle back the flux in the overall pathway by triggering cellular toxicity and/or pathway substrate inhibition.

In addition, formulations minRxn or minFlux can be augmented to control the number of organisms from which reactions are sourced in the construction of the conversion network to less than p^{o}.

$$\begin{matrix}{x}_{j} \leq M {\sum }_{o} {r}_{o} {org}_{oj} , ∀ o ∈ O & ( 19 ) \\ {\sum }_{o} {r}_{o} \leq {p}^{o} & ( 20 ) \\ {r}_{o} ∈ \{ 0 , 1 \} & ( 21 )\end{matrix}$$

Here, parameter orgₒⱼ has a value of one if reaction j is present in organism o, and zero otherwise. Using binary variable rₒ, Constraint (19) ensures that a reaction j cannot carry any flux unless it is present in at least one organism o

$$( i . e . , {\sum }_{o} {r}_{o} \geq 1 ) .$$

Constraint (20) sets an upper bound p^{o} on the number of organisms contributing reactions. One can avoid selecting the host organism a priori, thus allowing the optimization formulation to select the production host(s) best suited to construct the synthetic network. In addition, the definition of set O can be altered accordingly to minimize diversity in chosen genus instead of individual organisms. Alternatively, the production host could be pre-specified and then restrict the total number of heterologous reactions.

### 1.2 Results

The two-step stoichiometry and intervening reaction design procedure was implemented for three case studies that highlight the potential of the present invention in identifying novel stoichiometries and network designs. The first study explores pathways that successfully disassemble glucose to acetate with maximum carbon yield. The second study explores the reverse problem of identifying new ways of forming carbon-carbon bonds from methanol and CO₂ to feasible C₂₊ products. Finally, the third study identifies overall stoichiometries for converting methane to acetate by identifying suitable co-reactant and co-product pairs to drive forward the thermodynamically unfavorable methane to acetate conversion.

### 1.2.1 Case Study 1: Synthetic Pathways for Fully Converting Glucose to Acetate

Conversion of glucose through central carbon metabolism to acetyl-CoA (through EMP glycolysis or Entner-Doudoroff pathway) is required by most microorganisms for the production of biomass precursors and cofactors [43]. These pathways are also often recruited for the production of various bioproducts in a variety of production hosts. The generation of ATP and redox equivalent for growth, however, comes at the expense of losing two carbon atoms per glucose molecule as carbon dioxide reducing carbon yield to a maximum of 67%. Alternate modes of glucose metabolism, such as the glycerate pathway [44] lead to the same carbon loss. An exception to this rule is found in some clostridial [45] and lactate-producing bacteria [46] that use a phosphoketolase enzyme to process glucose without any carbon loss as CO₂. Recently, a synthetic, non-oxidative glycolysis (NOG) was designed and assembled demonstrating the feasibility of this concept [30] for bio-conversions. By expressing in E. coli heterologous phosphoketolase enzymes xylulose-5-phosphate phosphoketolase (XPK, E.C.#4.1.2.9) and fructose-6-phosphate phosphoketolase (FPK, E.C.#4.1.2.22) from B. adolescentis Bogorad and co-workers [30] assembled three cyclic networks demonstrating complete conversion of glucose to acetate. In this case study, we benchmark the present invention for the same conversion and explore additional network designs beyond the ones described in Bogorad and co-workers [30].

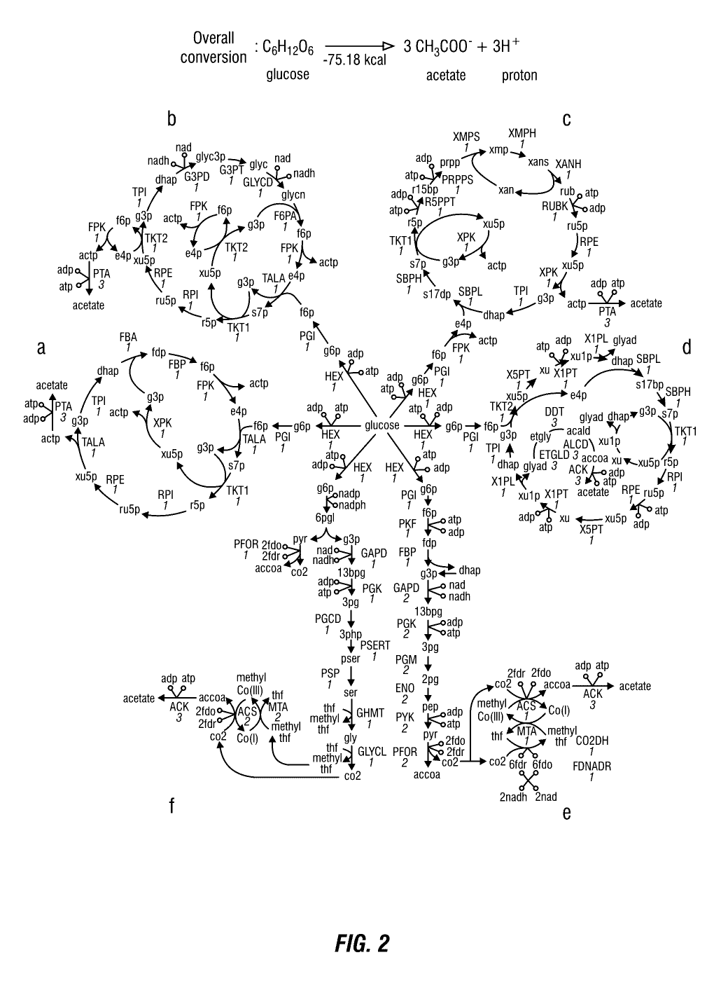

The first step, (i.e., OptStoic) here is redundant as the overall stoichiometry in the form of A→3B is fixed. Only networks that conserve all carbon flux from glucose to acetate satisfy the imposed overall stoichiometry. Results from both minRxn and minFlux converged to the same designs that achieve the overall conversion albeit with substantial differences in computational time. The smallest network (FIG. 2A) recapitulated the engineered construction of Bogorad and co-workers [30] where glucose undergoes a stepwise conversion to acetyl phosphate (actp) in a cyclic route. First, FPK cleaves fructose-6-phosphate (f6p) to erythrose-4-phosphate (e4p) and acetyl phosphate (actp). Next, e4p follows the reversal of Pentose Phosphate Pathway to produce two molecules of xylulose-5-phosphate (xu5p). Deacetylation of xu5p to glyceraldehyde-3-phosphate (g3p) by XFP produces two additional molecules of actp. Conversion of g3p to f6p through the reversal of upper glycolysis completes the cycle. Acetate kinase (ACK, E.C.#2.3.1.8) hydrolyses the three actp molecules to terminal acetate. A number alternate routes using FPK or XPK as the sole deacetylating reaction were identified similar to those constructed in Bogorad and co-workers [30] (see FIG. 2B for one of the constructions). Note that in this network design the need for cofactors nadh and nad is balanced with a zero net requirement. minRxn/minFlux can also be used to directly limit the number of reactions with a positive standard free energy of change. While both NOG and all designs shown in FIGS. 2A, B, D, E and F require at least two reactions with a positive standard free energy change, the design depicted in FIG. 2C involves a single reaction with positive ΔG⁰ whereby the thermodynamically unfavorable conversion of r5p to ru5p is avoided by routing the Pentose Phosphate Flux through C₅ metabolism of phosphoribosyl pyrophosphate (prpp) and ribulose (rub) in E. coli. However, as a tradeoff this cycle consumes one additional ATP compared to other designs. Networks not involving any CO₂ production through the phosphoketolase can also be designed (see FIG. 2D) where glucose uses the modified RuMP pathway to produce three molecules of ethylene glycol. Diol dehydratase (DDT, E.C.#4.2.1.28 [47]) removes a water molecule from ethylene glycol to synthesize acetaldehyde (acald), which can be oxidized to acetate in three steps. This route can be potentially advantageous for the co-utilization of five and six carbon substrates [48].

We next explored whether it is possible to construct the entire pathway in a single organism unlike the engineered NOG pathway that requires at least one heterologous enzyme (i.e., either FPK or XPK). FIG. 2E illustrates one such design with reactions from only clostridial species such as C. ljungdahlii [49] or thermophilic organisms such as Moorella thermoacetica [50]. Here, the EMP pathway is combined with the Wood-Ljungdahl cycle to fix the CO₂ lost in the conversion of pyruvate (pyr) to acetyl-CoA. Two pyr molecules (from one glucose molecule) are decarboxylated by the pyr ferredoxin oxidoreductase enzyme (PFOR, E.C.#1.2.7.1) [51] to acetyl-CoA and CO₂. Subsequently, one CO₂ molecule enters the western branch of Wood-Ljungdahl cycle where it is reduced and fixed with thf to methf. Next, methf enters the eastern branch of Wood-Ljungdahl pathway to condense with the second CO₂ molecule to synthesize the third molecule of acetyl-CoA. Conversion of acetyl-CoA to acetate completes the pathway. Note that all network designs introduced here (see FIG. 2) have a net zero ATP balance as specified in the overall stoichiometry. In contrast, the NOG pathway can produce two ATP molecules (per glucose molecule) from actp hydrolysis. By combining glycolysis and Wood-Ljungdahl we can in principle provide five ATP molecules (see FIG. 2E). However, thermodynamic constraints on the overall conversion (i.e., (i.e., ΔG^{overall}≦−5 kcal) do not allow more than three ATP to be generated. While the ATP generation efficiency of this pathway can be controlled by tuning the ATP and non-ATP producing isozymes of ACK, an alternate pathway (see FIG. 2F) with optimum generation of three ATP can be constructed using enzymes in the ED pathway. Here, the serine metabolism is utilized instead of the western branch to generate methf. However, practical hurdles in fixing all the CO₂ released in pyruvate decarboxylation (PFOR) and glycine cleavage (GLYCL, E.C.#1.4.4.2) may make these pathways difficult to engineer.

In this example, we saw how optimization formulations minRxn/minFlux can be used to select reactions that fully convert glucose to acetate while exploring the impact of minimizing reactions with a positive ΔG⁰, selection of production host and minimality of reactions in the designed conversion pathway.

### 1.2.2 Case-Study 2: Co-Utilization of Methanol and Carbon Dioxide to C₂₊ Compounds

In the second case study, we focus on the design of the overall conversion when not all participating metabolites are known a priori. A recent study proposed and constructed a biological route for the direct condensation of methanol to ethanol [32] with 100% efficiency of carbon conversion. This motivated us to explore novel designs that can simultaneously convert methanol and co-utilize CO₂ towards C₂₊ product metabolites with zero loss of carbon flux (i.e., A+C→B reaction). Here, unlike the previous case study, product metabolite B is unknown and could potentially be any of the 3330 C₂₊ metabolites in set I. The negative free energy of change for methanol condensation (ΔG=−16.25 kcal mol⁻¹) allows for the endergonic uptake of some CO₂ to become thermodynamically feasible. As a result, designed pathways have the potential to achieve higher carbon efficiency than existing methanol condensation routes [32] while also exhaustively exploring all possible C₂₊ product metabolites.

We chose maximization of the coefficient of CO₂ in the overall stoichiometry as the design objective in optStoic while keeping the methanol coefficient at a value of one. This objective function maximizes the carbon yield of the desired product per mole of the limiting reactant (methanol). As many as 148 target metabolites from set I were identified as thermodynamically feasible products for the conversion (see Supplementary File S5 for full list). Table 1 shows ten of the designs in decreasing order of CO₂ uptake. CO₂ uptake varies in concert with the oxygen to hydrogen ratio (O:H) in the product metabolite. For example, malonate (C₃H₄O₄), which has a O:H ratio of one has the largest stoichiometric coefficient for CO₂ (i.e., 1.25), while 2-methyl butanal (O:H=0.1) has the lowest (0.0714). As hydrogen availability in the reactants is fixed (stoichiometry of methanol is fixed to one), a low O:H ratio in the product reduces water production to satisfy elemental hydrogen balance. Because the oxygen atoms in CO₂ are routed to water for products with low O:H ratio, reduced water production limits caused by the fixed availability of H, reduces the co-utilization of CO₂ and thus overall carbon yield. It is important to note that the O:H ratio is also critical in deciding whether a desired metabolite is a feasible target product. For example, several platform chemicals such as ethylene glycol (O:H=0.33), 1-butanol (O:H=0.125) and 1,3-propanediol (O:H=0.25) are not feasible solutions as mass conservation of hydrogen and oxygen cannot be simultaneously satisfied in the overall stoichiometry. Furthermore, metabolites with a very high O:H ratio, such as oxalate (O:H=2) and glyoxylate (O:H=1.5) are also not feasible due to limitations in oxygen atoms availability from CO₂. Therefore, constraints of the overall design stoichiometry determine the feasibility of the target products as well as their maximum yields. It appears that in all designs thermodynamic feasibility is not the limiting constraint, instead elemental balances for H and O limit overall reaction stoichiometries.

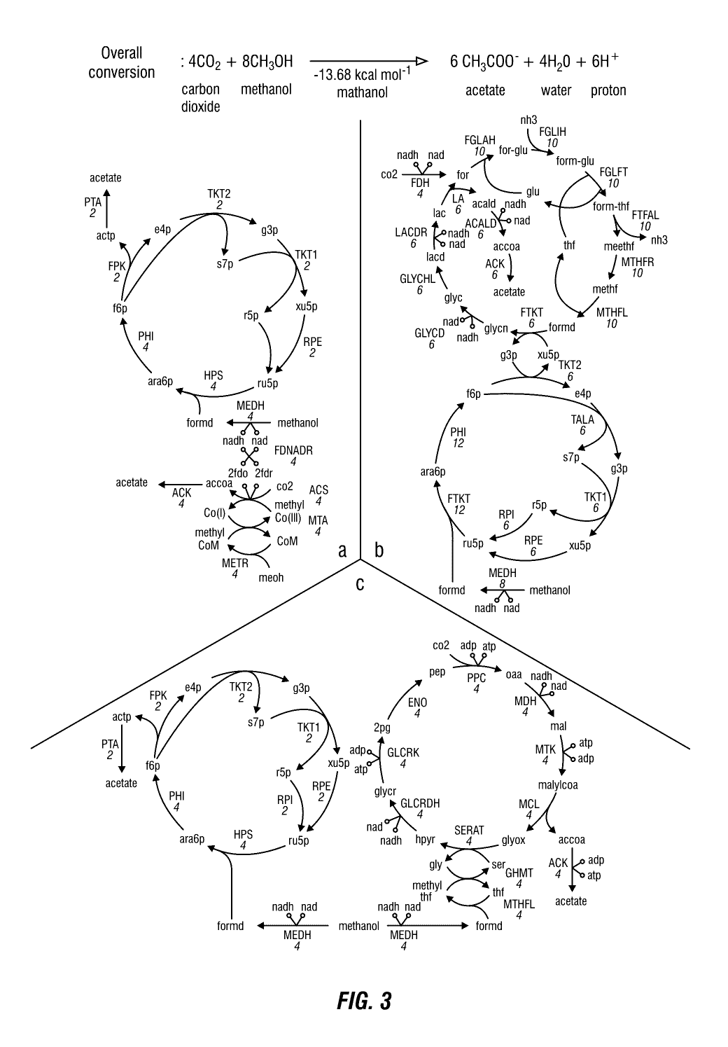

From Table 1, we selected four products (i.e., acetate, 3-hydroxybuyrate, 2-ketoisovalerate and phloroglucinol) for constructing networks satisfying their overall reaction stoichiometry (see FIG. 3). Both 3-hydroxybuyrate and 2-ketoisovalerate are platform chemicals [52] that also serve as precursors to other biochemicals [28,52] while phloroglucinol is a phenolic derivative used as a building block for cosmetics [53] and explosives [54]. Note that for the construction of the networks we scaled up the overall stoichiometry such that all the coefficients are integers. Optimization formulations minRxn/minFlux revealed that the optimal reaction networks for each conversion involved a common core of reactions that initially convert the C₁ substrates to an intermediate product (i.e., acetyl-CoA), which was subsequently routed towards the final product. As a result, the first example (acetate production) spans alternate routes of fixing CO₂ with methanol to acetyl-CoA (and acetate). Each one of the identified networks is subsequently coupled with additional reactions to synthesize the three other target products (i.e., 3-hydroxybuyrate, 2-ketoisovalerate and phloroglucinol). The optimal network for converting methanol and CO₂ to acetate is divided into two modules (see FIG. 3A). The first module condenses four molecules of CO₂ and methanol to synthesize four acetyl-CoA molecules using a combination of methylotropic and Wood-Ljungdahl pathway enzymes. The methyl group of methanol is transferred to Corrinoid protein by CoM-Corrinoid methyltransferases (MTA, E.C.#2.1.1.90 and 2.1.1.246) [55,56], which subsequently condenses with CO₂ to acetyl-CoA by acetyl-CoA synthase (ACS, E.C.#1.2.7.4 and 2.3.1.169) enzyme from the Wood-Ljungdahl pathway [57]. The reducing equivalents (ferredoxin) required for powering this conversion is supplied by methanol oxidation in methanol dehydrogenase (MEDH, E.C.#1.1.1.244) in the second module. This module assembles an alternative methanol condensation [32] cycle where four formaldehyde molecules enter a modified ribulose monophosphate (RuMP) Pathway [58] to condense to two actp molecules. Hexulose-6-phosphate synthase (HPS, E.C.#4.1.2.43) and 6-phospho-3-hexulo isomerase (PHI, E.C.#5.3.1.27) found in methylotrophs [58] fix formed into the five-carbon ru5p backbone which is subsequently cleaved in FPK. Pentose Phosphate enzymes convert the intermediate substrates back to ru5p to complete the cycle using reactions also present in the NOG cycle.

TABLE 1
Overall stoichiometry designs for the conversion of methanol and CO₂ to C₂₊
metabolites

| Product | Stoichiometry | O:H ratio |
|---|---|---|
| Malonate | 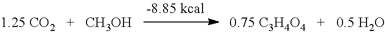 | 1.00 |
| Citrate | 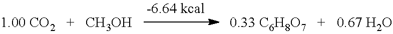 | 0.88 |
| Succinate | 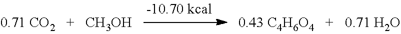 | 0.67 |
| Acetate | 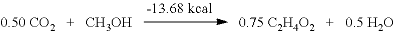 | 0.50 |
| Phloroglucinol | 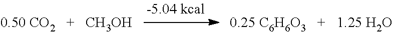 | 0.50 |
| 3-Hydroxypropionate | 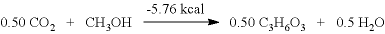 | 0.50 |
| 2-Ketoisovalerate | 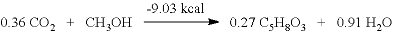 | 0.38 |
| 3-Hydroxybutyrate | 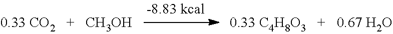 | 0.38 |
| 2,3-Butanedoil | 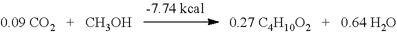 | 0.20 |
| 2-Methylbutanal | 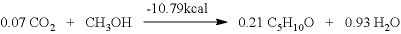 | 0.10 |

The design shown in FIG. 3A requires the fewest number of reactions, however, the oxygen-sensitive nature of the Wood-Ljungdahl enzymes (MTA, ACS) [32] would be a practical concern. The second synthetic design (see FIG. 3B) uses histidine degradation metabolism [59] and formate dehydrogenase (FORMD) from Clostridia [60] to fix CO₂ for acetate production. Here, the RuMP cycle is altered to convert formaldehyde to glycerone instead of actp. Formaldehyde transketolase (FTKT, E.C.#2.2.1.3) from methylotropic yeasts such as P. pastoris [61]) is the only additional reaction required to fix an additional formaldehyde molecule with xu5p, and subsequently cleave it to glycerone. Subsequently, glycerone follows lactate metabolism to acetaldehyde (acald) (in Lactate Aldolase (LA, E.C.#4.1.2.36)), and oxidation of acetaldehyde completes the network.

A third design using predominantly E. coli reactions was also identified. Here, while half of the formaldehyde molecules (from methanol) are fixed in the modified RuMP cycle, the rest is fixed along with CO₂ in a functional reversal of the glyoxylate shunt [62]. Here, glyoxylate is converted to glycine uses the folate-driven C₁ metabolism in serine pathway to fix the remaining formaldehyde molecules. C₁ metabolism in the serine pathway is combined with serine-glyoxylate aminotransferase (SERAT, E.C.#2.6.1.45) to fix the remaining formaldehyde to glyoxylate and produce hydroxypyruvate (hpyr). Phosphenolpyruvate (pep), from the reduction of hpyr in glycerate metabolism, fixes atmospheric CO₂ in the anaplerotic pep carboxylase enzyme (PPC, E.C.#4.1.1.49). This flux is routed through malyl-CoA (in ATP-driven malate thiokinase (MTK, E.C.#6.2.1.9) [62]) to be cleaved to produce acetyl-CoA and glyoxylate by malyl-CoA ligase (MCL, E.C.#4.1.3.24). As all the reactions in this network are either native to E. coli or have been successfully expressed in prior studies (PC, MTK, MCL) [62,63], it has the fewest potential barriers for its implementation.

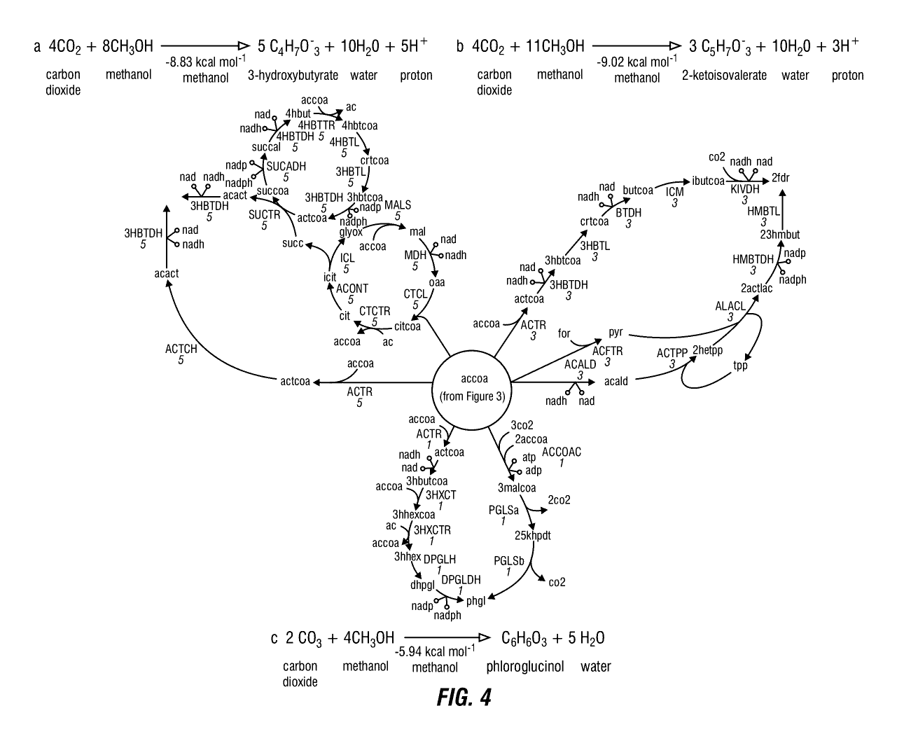

Each one of these cyclic routes can be combined with additional paths to route acetyl-CoA flux towards other target chemicals. FIGS. 4A, B and C show routes for converting methanol and CO₂ to a C₄, a C₅ and a C₆ product, respectively. Pathways for 3-hydroxybutyrate (3hbut) recapitulate existing engineered routes through acetoacetyl-CoA [64,65] while also proposing additional synthetic designs that use succinate metabolism and reversal of the β-oxidation pathway (see FIG. 4A). In addition to thiamine-dependent valine synthesis for 2-ketoisovalerate (2kiv) production [66], a novel route path linking β-oxidation reversal with valine degradation is also identified (see FIG. 4B). Here, n-butanoyl-CoA in the C₄ β-oxidation cycle is isomerized to isobutyryl-CoA (ibutcoa) in iso-butyryl-CoA mutase (ICM, E.C.#5.4.99.13) [67]. Reversal of 2-ketoisovalerate oxidoreductase (KIVR, E.C.#1.2.1.25) in the valine degradation pathway converts 2-mpropcoa to the target product. In the case of phloroglucinol production, however, the traditional pathway using malonyl-CoA metabolism [68] was not identified by minFlux as it violates the energy requirement for the acetyl-CoA carboxylase (ACCOAC, E.C.#6.4.1.2) step. Instead, acetyl-CoA was converted to hydroxyl-butyryl-CoA (hbutcoa) which incorporates an additional acetyl-CoA molecule to form 3-hydroxy-5-oxohexanoyl-CoA (in 3-hydroxy-5-oxohexanoyl-CoA thiolase (HXCOAT, E.C.#2.8.3.8)). Cyclization and reduction of this molecule synthesizes phloroglucinol.

This example highlights several of the advantages of the present invention over existing pathway prospecting tools. First, we can set well-defined cutoffs for the performance of the pathway that do not require any post-processing steps unlike existing procedures [17,28,69]. Strict constraints of thermodynamics and overall stoichiometry filter out suboptimal routes and unbalanced conversions. The designs are not restricted to be linear paths [23,27,28] from a substrate to the product, but can explore cyclic routes connected not only by carbon transfer, but also through cofactor balances. More importantly, instead of exploring only A→B type of conversion [17,70], the networks can satisfy complex stoichiometries where the participating metabolites and their coefficients can be design variables. In addition, as seen in the first case study, the performance criteria for each of the two steps (i.e., the overall design and pathway construction) can be altered to match the specific requirements of the design.

### 1.2.3 Case Study 3: Designing Thermodynamically Feasible Paths for the Conversion of Methane to Acetate

In the previous case study, only co-product (B) was unknown in the overall conversion. In the third case study, both co-reactant (C) and co-product (D) are design variables. With increased production of methane from natural gas deposits through advanced extraction technologies [71], there is a growing interest of engineering metabolic routes of fixing this gaseous feedstock to C₂₊ liquid biofuel and biochemical targets [72]. However, the overall conversion creating a C—C bond by fixing methane with a C₁ co-substrate (e.g., atmospheric CO₂, CO from syn gas, etc.) is thermodynamically unfavorable (e.g., ΔG=11.05 kcal for CH₄+CO₂→CH₃COOH reaction). Recent studies have suggested that such a conversion can be achieved when coupled with a suitable electron acceptor [73,74]. Several anaerobic microorganisms have evolved ways to couple oxidation of methane with reduction of electron acceptors such as nitrite, sulfate ⁷⁹, iron and manganese ⁸⁰. In this study, we first identify all electron acceptors that could be used to convert methane to acetate (C₂ product) and rank them according to their carbon yield to acetate. Subsequently, we select five solutions from the list of feasible electron acceptors to design pathways that convert methane and a C₁ co-substrate (CO₂ or CO) to acetate along with a C₂₊ platform chemical [1,75].

Using optStoic and keeping the stoichiometry of acetate fixed at one (as basis), we maximized the stoichiometric coefficient of methane while allowing the production of up to two additional metabolites from set I. Non-carbon containing metabolites including metal ions, anions, protons and water were included as candidates in the overall stoichiometry. optStoic identified many distinct designs with alternative electron-acceptor combinations. Ten designs are shown in Table 2 (see Supplementary File S6 for all the designs). Here, the overall reaction stoichiometry has been rescaled for unit molar consumption of the electron acceptor. The only feasible stoichiometry with a single additional co-metabolite was oxygen. We did not analyze further this stoichiometry as designs for aerobic conversion of methane have already been explored extensively [72,76]. Results demonstrate the varying capacity of different electron-accepting pairs in oxidizing methane to acetate due to thermodynamic considerations. The reduction of one mole of tetrathionate (S₄O₆²⁻) to hydrogen sulfide (H₂S) accepts the maximum number of electrons (eighteen) thus converting 4.5 moles of methane to 2.25 moles of acetate. In contrast, one mole of iron(III)/iron(II) reduction (Fe³⁺/Fe²⁺) oxidizes only 0.25 moles of methane as it accepts only one electron. The electron acceptor pair S₄O₆²⁻/H₂S also supplies the oxygen required for the carbonyl group in acetate and oxidize additional hydrogen in methane to water. Most of the electron accepting pairs such as nitrate/nitrite (NO₃⁻/NO₂⁻) and sulfite/hydrogen sulfide (HSO₃⁻/H₂S) perform both tasks. Only pair Fe³⁺/Fe²⁺ performs the role of electron acceptor while water supplies the oxygen. Note that the commonly found electron pair sulfate/hydrogen sulfide reduction (SO₄²⁻/H₂S) utilized by several marine anaerobic consortia for methane oxidation [77,78] was not identified as a feasible solution as ΔGₒᵥₑᵣₐₗₗ of the reaction (−4.41 kcal mol⁻¹ acetate) was below the allowable ΔGₘᵢₙ (−5 kcal mole⁻¹ acetate) set for this case study.

For the second step of optStoic we selected five pairs of electron acceptors from Table 2 (i.e., NO₃⁻/NO₂⁻, HSO₃⁻/H₂S, NO₂⁻/NH₄⁺, Fe³⁺/Fe²⁺ and HSO₃⁻/S₂O₃²⁻) with different efficiencies of methane fixation per mole of oxidizing metabolite. For a unit mole conversion of each pair, we searched for a stoichiometry that further improves methane uptake by allowing for up to two additional metabolites from set I (similar to Step 1). The co-substrates were restricted to CO₂ and CO while the co-products were chosen from all C₂₊ compounds (3330 in set I). Table 3 compares ten of the designs for HSO₃⁻/H₂s and NO₃⁻/NO₂⁻ electron acceptors. Both acceptors exhibit the same general trend with products with higher carbon ratio have higher stoichiometry of methane uptake (per unit mole of acetate production). In contrast to Case Study 2, it was the thermodynamic feasibility of the overall reaction and not the O:H ratio of the product that was limiting methane utilization. By allowing both the reactant and co-reactant stoichiometries to vary we have an additional degree to freedom to match the O:H ratio of the target product and maximize methane utilization all the way to the thermodynamic limit (i.e., ΔG^{overall}=−5 kcal). It is also interesting to note that NO₃⁻/NO₂⁻ allows for much higher efficiency of methane fixation compared to HSO₃⁻/H₂S. This is also because the thermodynamic driving force and not the electron-accepting capability of the electron acceptor becomes the limiting factor in this case.

TABLE 2
Ten feasible electron acceptors for driving conversion of methane to acetate

| Electron acceptor | Stoichiometry |
|---|---|
| Tetrathionate/Hydrogen Sulfide | 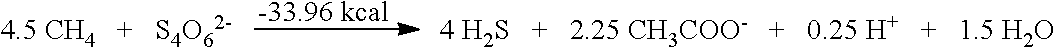 |
| Nitrate/Ammonium | 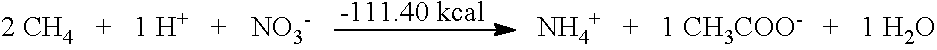 |
| Thiosulfate/Hydrogen Sulfide | 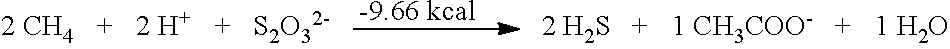 |
| Bisulfite/Hydrogen Sulfide | 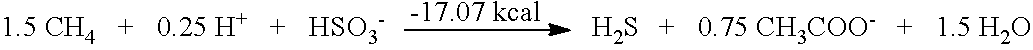 |
| Nitrite/Ammonium | 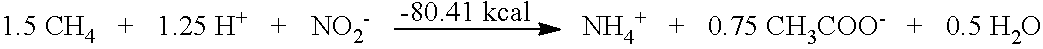 |
| Nitrous Oxide/Hydroxylamine | 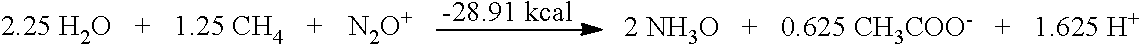 |
| Nitrite/Nitrite | 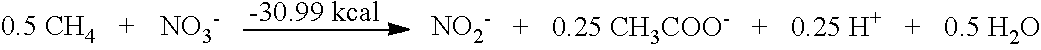 |
| Bisulfite/Thiosulfate | 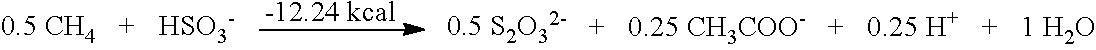 |
| Sulfur dioxide/Tetrathionate | 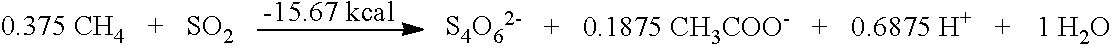 |
| Iron(III)/Iron(Il) | 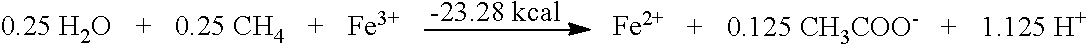 |

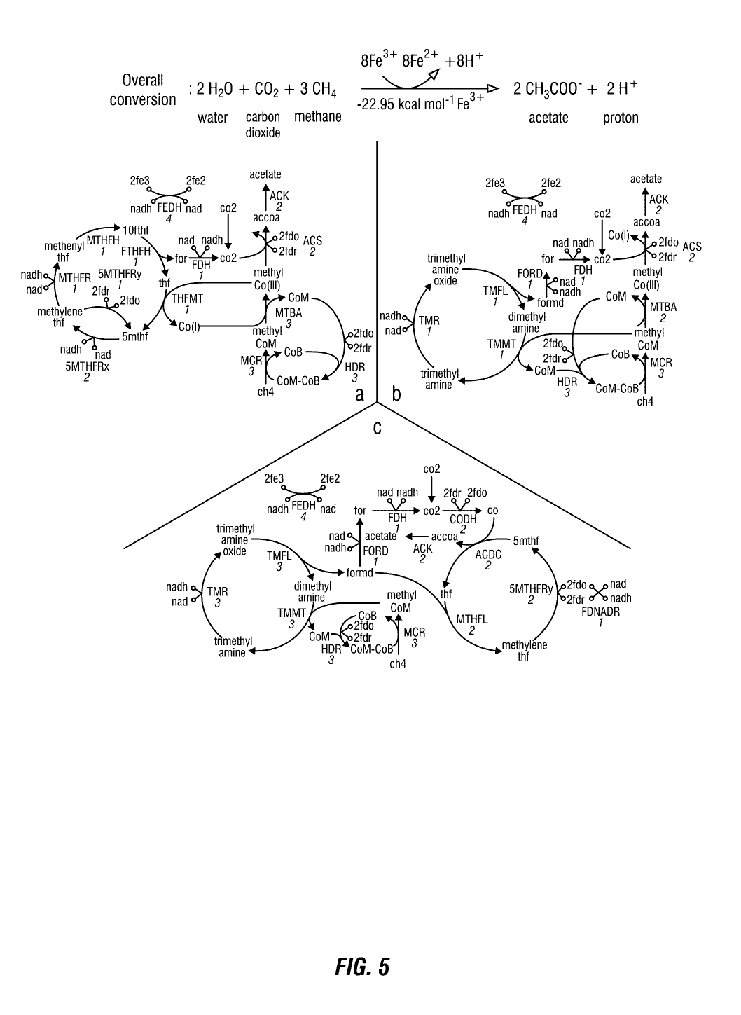

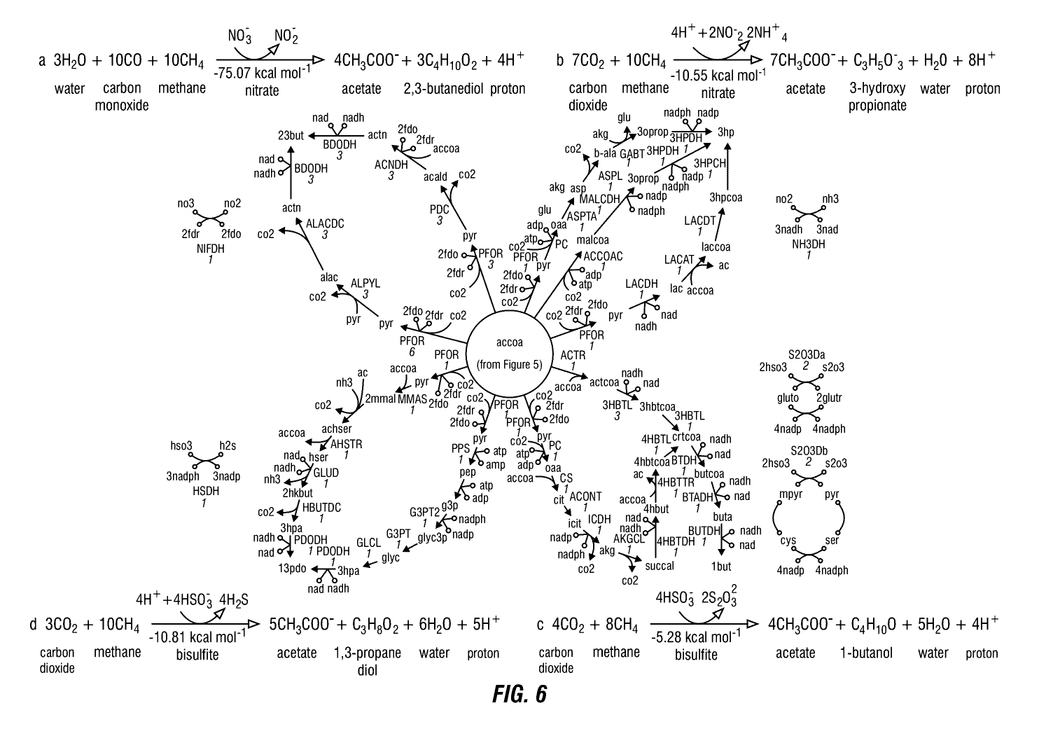

Each of the five electron acceptors was used to suggest minimal networks for fixing methane to a different target product (see FIGS. 5 and 6). Similar to previous study, results showed that a core set of reactions first converted methane and the co-reactant to intermediate acetyl-CoA. We used the first design (i.e., Fe³⁺/Fe²⁺ for acetate production) to

TABLE 3
Limiting overall stoichiometries for acceptor pairs HSO₃⁻/H₂S and NO₃⁻/NO₂⁻
for five target products. All the overall stoichiometries maximize methane uptake for
unit molar conversion of each electron acceptor and unit molar production of acetate.

| Product | Stoichiometry (HSO₃⁻/H₂S) | Stoichiometry (NO₃⁻/NO₂⁻) |
|---|---|---|
| Isobutanoate | 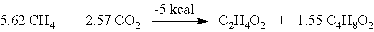 | 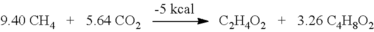 |
| Succinate | 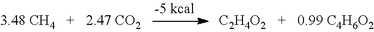 | 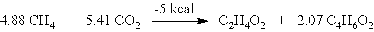 |
| 1-Butanol | 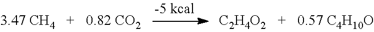 | 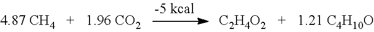 |
| Acetone | 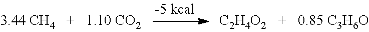 | 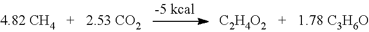 |
| Isopropanol | 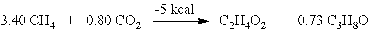 | 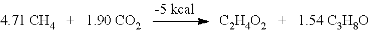 |
| 1-Propanol | 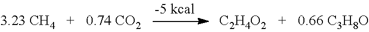 | 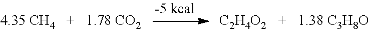 |
| 2,3-Butanediol | 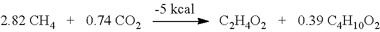 | 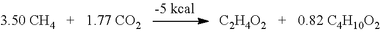 |
| 3-Hydroxypropionate | 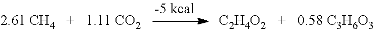 | 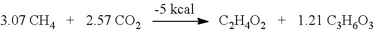 |
| 1,3-Propanediol | 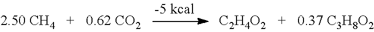 | 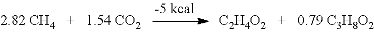 |
| Ethylene glycol | 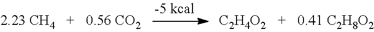 | 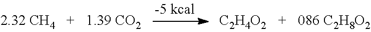 |

describe existing and novel routes of fixing methane and CO₂ (or CO) to acetate (see FIG. 5). Additional designs concentrate on the paths from acetate to the final products (see FIG. 6). All designs reveal that the terminal acceptors exchanged electrons with a cofactor pair instead of directly catalyzing a reaction in the carbon-transfer network. Different cofactors were identified for the electron acceptors depending on the reduction reactions in the network. For example, Fe³⁺/Fe²⁺ and No₂⁻/NH₄⁺ use nadh as the electron donor, catalyzed by NAD:Fe oxidoreductase (E.C.#1.16.1.7, from denitrifying bacteria such as P. denitrificans [79]) and ammonia oxidoreductase (E.C.#1.16.1.15, from E. coli [80]) respectively. In contrast, HsO₃⁻/H₂s exchanges electrons with napdh using sulfite reductase (e.g., in E. coli [81], E.C.#1.8.1.2), while reduced ferredoxin does the same for NO₃⁻/NO₂⁻ using a nitrite oxidoreductase (e.g., from N. gracilis [82], E.C.#1.7.7.2). In some cases photosynthetic enzymes found in plant chlorophylls were initially suggested such as ferredoxin-dependent thiosulfate reductase (E.C.#2.8.1.3, from A. thaliana [83]) for HsO₃⁻/S₂O₃²⁻ (see FIG. 6C). Upon excluding them an alternate mechanism was identified by minFlux where HSO₃⁻ is converted to S₂O₃²⁻ through the oxidation of mercaptopyrvate (to pyruvate) by sulfurtransferases (E.C.#2.8.1.2) found in E. coli [84] (see FIG. 6C). Note that a few of the designs require electron transfer between NAD(P)H and ferredoxin for regeneration of reduced ferredoxin (fdr) (e.g., see FIGS. 5B and C). While the free energy change under standard conditions suggests that this reaction is favorable only in reverse (i.e., ΔG_{nad/fd}=3.83 kcal [85]), there exists multiple experimental evidence alluding to the feasibility of electron transfer from NAD(P)H to ferredoxin [86].

FIG. 5 shows three alternate routes for the conversion of three molecules of methane and one molecule of CO₂ to two acetate molecules with Fe³⁺/Fe²⁺ as the terminal electron acceptor. The smallest network (FIG. 5A) describes a functional reversal of the methanogenesis pathway where a molecule of methane and CO₂ combine to synthesize acetyl-CoA. Acetyl-CoA is subsequently hydrolyzed to acetate. The key enzymes in this pathway are CoM reductase (MCR, E.C.#2.8.4.1), Corrinoid methyltransferase (MTBA, E.C.#2.1.1.246), heterodisulfide reductase (HDR, E.C.#1.8.98.1) and the acetyl-CoA synthase (ACS), all found in most methanotropic archaea and some methylotrophs [74]. However, in order to maintain the 1:1 stoichiometric balance of methane and CO₂ in ACS reaction, one molecule of methane is oxidized to CO₂ in a complex three-step cyclic route involving a functional reversal of the eastern branch of the Wood-Ljungdahl pathway. First, thf is converted to 5-methyl thf (mthf) by transferring methyl group from methyl Corrinoid protein homologous to MTBA reaction [87]. This substrate is subsequently oxidized by nad or ferredoxin cofactors (according to stoichiometric demands of each cofactor) and hydrolyzed to formate. Formate dehydrogenase (FDH, E.C. #1.2.1.2) oxidizes formate to CO₂. Likewise, alternate routes for oxidizing methane can also be engineered that directly oxidizes methyl-coM to CO₂ in the methylamine cycle. Here, the methyl group is transferred to dimethylamine (dma) in trimethylamine methyltransferase (TMMT, E.C. #2.1.1.247) that is homologous to MTBA [88]. Trimethylamine (tma), thus formed, is cleaved by tma oxide aldolase to produce formaldehyde. Oxidation of formaldehyde to CO₂ completes the network. The third bypasses the ATPS and MTBA reactions by combining the two previous cyclic networks. Here, CO₂ is first reduced to CO which is subsequently fixed to acetyl-CoA through the western branch of the Wood-Ljungdahl pathway (FIG. 5C). It must be noted that all the enzymes (except for the terminal electron acceptors) are present in most anaerobic methanogens that makes these networks easier to construct. This case study highlights the fact that the cofactor balances play a significant role in network-design. For example, the net reduction of 5-methyl thf to 5,10-methylene thf is accomplished by two opposite reactions involving nad and ferredoxin cofactors (FIG. 5A) in order to maintain the overall balance of individual cofactors.

FIG. 6 describes a few of the existing strategies and novel routes of for maximizing the production of four platform chemicals (i.e., 2,3-butanediol, 3-hydroxypropionate, 1-butanol and 1,3-propanediol [52,75]), each utilizing a different electron acceptor. In addition to existing routes of synthesizing the target product, we also identified alternate pathways with equal or higher carbon yields. For example, 2,3-butanediol (23but) could be synthesized from acetyl-CoA by first converting it to pyruvate (using pyruvate-ferredoxin oxidoreductase (PFOR) [51]) with subsequent dimerization to acetolactate (see FIG. 6A). Decarboxylation of acetolactate followed by reduction of acetolactate produces 2,3-butanediol. While standard pathways (from pyruvate [89]) lose two carbon atoms for each molecule of 23but, this pathway preserves all the carbon molecules as the lost CO₂ is compensated in the PFO step. It is interesting to note that this pathway uses the same enzymes (except the MTBA reaction) of converting CO to 23bdo in a recent study in three separate acetogenic Clostridial species [34] as well as functionally expressed in E. coli [90]. This shows how overall stoichiometry constraints leverage known routes to allow for the uptake of co-reactants (methane in this case) that improves the overall carbon efficiency of conversion. An alternate pathway was also identified where one acetyl-CoA molecule is oxidized to acetaldehyde, which combines with a second acetyl-CoA molecule to form acetoin through the reversal of acetoin dehydrogenase (ACTDH, E.C. #2.3.1.190) found in acetoin consuming bacteria such as E. aerogenes [91].

Three pathways were identified for 3-hydroxypropionate (3 hp) production all of which have been explored previously (see FIG. 6B). While the first two paths hydrolyze and reduce pyruvate through lactate [92] and β-alanine [33] as intermediates, the third pathway (and shortest) path utilizes malonyl-CoA reduction [93]. However, unlike the first pathway, the other two are less energy-efficient due to an additional ATP requirement for pyruvate carboxylase (PC) and acetyl-CoA carboxylase (ACCOAC, E.C.#6.4.1.2) reactions respectively. Similarly, the shortest route for 1-butanol production (FIG. 6C) recapitulates existing strategies involving condensation of two molecules of acetyl-CoA in accoa acetyltransferase (ACT, E.C.#2.3.1.9) followed by a functional reversal of the β-oxidation pathway [31,94,95]. A so far unexplored pathway is also suggested that combines the oxidative branch of TCA cycle with succinate-semialdehyde metabolism to reach 1-butanol. Here, pyruvate (from acetyl-CoA) is first carboxylated to oxaloacetate in the ATP-dependent pyruvate carboxylase reaction (PC). The TCA cycle converts oxaloacetate and acetyl-CoA to 2-oxoglurate, which is decarboxylated to succinate-semialdehyde in akg decarboxylase (AKGCL, E.C. #4.1.1.71 found in Synechocystis [96]). Reduction of succinate semialdehyde, similar to β-oxidation reversal synthesizes 1-butanol. In the case of 1,3-propanediol (see FIG. 6D), the only identified pathway converts acetyl-CoA to pyruvate which is reduced back to g3p through gluconeogenesis. Glycerol, from g3p, is subsequently reduced to 13pdo in three steps by the native (e.g., in some Clostridia [97]) or engineered enzymes found in E. coli and K pneumonie (i.e., the DuPont pathway [98]). The present invention could not identify an alternate pathway in E. coli [99] where homoserine (hser) flux is routed towards 3-hydroxypropanal (2hpa) by engineering the native glutamate dehydrogenase to be promiscuous towards homoserine. The reason is because the intermediate metabolite 4-hydroxy-2-oxobutyrate (4hkbut) in the pathway as well as the reactions associated with the molecule (see FIG. 6D in red) was absent in our database. Upon inclusion of the metabolite and the reactions, minFlux could identify this pathway as an alternate more energy efficient route for 13pdo production.

In this study we identified and rank-ordered feasible electron acceptor pairs according to their methane oxidation potential. Unlike the previous example, thermodynamic feasibility and not elemental balances becomes the limiting factor in determining the optimum stoichiometric ratios in the overall reaction. minFlux identified relevant cofactor systems that coupled the methane utilization pathway with the terminal electron acceptors.

### 1.3 Discussion

The present invention develops a two-step computational procedure (optStoic+minRxn/minFlux) for designing de novo networks that match an overall stoichiometry of chemical transformation. Performance criteria on the designed pathways (e.g., carbon yield/energy efficiency, pathway ΔG etc.) can systematically be imposed and rank-order synthetic pathways according to the design objective. The three examples highlight the potential of this procedure for designing a thermodynamically feasible overall conversion stoichiometry, selecting the optimum combination of co-metabolites and co-products, and constructing non-intuitive synthetic biological routes for the overall conversion.

For the most part existing databases such as MetRxn [35] or Kegg [100] span a very large population of intermediate metabolites that can be produced from the reacting metabolites. In contrast, the number of terminal pathways towards target products tends to be much more limited. For example, acetyl-CoA is associated with 153 reactions, while 13pdo and phloroglucinol are involved in one and two reactions, respectively. Therefore, most of the novel network designs suggested by minRxn/minFlux stemmed from alternate intermediate metabolites and ways of producing them. A potential way of expanding the diversity of network design would be to consider hypothetical biotransformations generated by successively applying reaction operators on metabolites [29,70]. For example, in a recent work for synthesizing platform chemicals in E. coli, GEM-Path [28] suggested a pathway for 13pdo production from malate that involved two de novo reactions. By combining minRxn/minFlux with compilations of hypothetical reactions and metabolites (e.g., BNICE [70], GEM-Path [28], XTMS[27]) the scope and diversity of designed synthetic networks would increase significantly. In addition, integration of kinetic (e.g., BRENDA [101]) and toxicity information [102] can be incorporated within minRxn/minFlux to further restrict the design space by avoiding kinetic bottlenecks and toxic intermediates.

### 2 Alternative Embodiments

The publications and other material used herein to illuminate the background of the invention or provide additional details respecting the practice are herein incorporated by reference in their entirety. The present invention contemplates numerous variations, including variations in organisms, variations in bioprospecting objectives, variations in types of optimization problems formed and solutions used. These and/or other variations, modifications or alterations may be made therein without departing from the spirit and the scope of the invention as set forth in the appended claims.

### APPENDIX

Abbreviation for terminal and intermediate metabolites taking part in minimal networks
10fthf 10-Formyltetrahydrofolate;
13bpg 1,3-Bisphospho-D-glycerate;
13pdo 1,3-Propanediol;
1but 1-Butanol;
23bdo (R,R)-Butane-2,3-diol;
23hmbut (R)-2,3-Dihydroxy-3-methylbutanoate;
2alac (S)-2-Acetolactate;
2hetpp 2-Hydroxyethyl-ThPP
2hkbut 4-hydroxy-2-oxobutyrate
2kiv 2-keto-iso-valerate
2mmal (R)-2-Methylmalate;
2pg 2-Phospho-D-glycerate;
3hbtcoa (S)-3-Hydroxybutanoyl-CoA;
3hbut (R)-3-Hydroxybutanoate;
3hhex 3-Hydroxy-5-oxohexanoate
3hhexcoa 3-Hydroxy-5-oxohexanoyl-CoA
3 hp 3-Hydroxypropanal
3hpcoa Propenoyl-CoA;
3oprop 3-Oxopropanoate;
3pg 3-Phospho-D-glycerate;
3php 3-Phosphonooxypyruvate;
4hbtcoa 4-Hydroxybutyryl-CoA;
4hbut 4-Hydroxybutanoic acid;
5mthf 5-Methyltetrahydrofolate
ac Acetate
acact Acetoacetate
acald Acetaldehyde
accoa Acetyl-CoA
achser O-Acetyl-L-homoserine;
actcoa Acetoacetyl-CoA;
actn Acetoin
actp Acetyl phosphate
akg alpha-Ketoglutaric acid
alac 2-Acetolactate
ara6p D-arabino-Hex-3-ulose 6-phosphate
asp L-Aspartate;
b-ala beta-Alanine;
buta Butanal
butcoa Butanoyl-CoA
butcoa Butanoyl-CoA;
ch4 Methane
cit Citrate
citcoa (3 S)-Citryl-CoA
co Carbon monoxide
co(I) Co(I) corrinoid protein
co2 Carbon dioxide
coa Coenzyme A
coB Coenzyme B
coM Coenzyme M
com-cob CoM-S-S-CoB
crtcoa Crotonoyl-CoA;
dhap Dihydroxyacetone phosphate
dhpgl Dihydrophloroglucinol
dkhpdt 3,5-diketoheptanedioate
dma Dimethylamine
e4p D-Erythrose 4-phosphate
etgly Ethylene glycol
f6p D-Fructose 6-phosphate;
fdo Oxidized ferredoxin
fdp D-Fructose 1,6-bisphosphate
fdr Reduced ferredoxin
fe2 Iron(2+)
fe3 Iron(3+)
for Formate
for-glu N-Formyl-L-glutamate
form-glu N-Formimino-L-glutamate
form-thf 5-Formiminotetrahydrofolate
formd formaldehyde
g3p D-Glyceraldehyde 3-phosphate
g6p D-Glucose 6-phosphate;
glc D-Glucose;
glu L-Glutamate
gluto Oxidized glutathione
glutr Reduced Glutathione
gly Glycine
glyad glycoaldehyde
glyc Glycerol
glyc3p sn-Glycerol 3-phosphate;
glycn Glycerone
glycr Glycerate
glyox Glyoxylate
h2s Hydrogen sulfide;
hpyr Hydroxypyruvate
hser L-Homoserine;
hso3 Sulfite
ibutcoa Isobutyryl-CoA
ibutcoa Isobutyryl-CoA
icit Isocitrate
lac L-Lactate
laccoa Lactoyl-CoA
lacd Lactaldehyde
mal Malate
malcoa Malonyl-CoA;
malylcoa Malyl-CoA
malylcoa Malyl-CoA;
me-co(III) Methyl-Co(III) corrinoid protein
me-coM Methylcoenzyme M
meethf 5, 10-Methenyltetrahydrofolate
meoh Methanol
methf 5, 10-Methylenetetrahydrofolate
mthgxl Methylglyoxal
nad NAD+
nadh NADH
nadp NADP+
nadph NADPH
nh3 Ammonia
no2 Nitrite
oaa Oxaloacetate
pep Phosphoenolpyruvate
phgl Phloroglucinol
prpp 5-Phosphoribosyl diphosphate;
pser O-Phospho-L-serine;
pyr Pyruvate
r15bp D-Ribose 1,5-bisphosphate;
r5p D-Ribose 5-phosphate;
rib D-Ribose
ru5p D-Ribulose 5-phosphate
s17bp Sedoheptulose 1,7-bisphosphate
s2o3 Thiosulfate
s7p Sedoheptulose 7-phosphate
s7p Sedoheptulose 7-phosphate;
ser L-Serine;
succ Succinate
succal Succinate semialdehyde;
succoa Succinyl-CoA;
thf Tetrahydrofolate
tma Trimethylamine
tmaox Trimethylamine N-oxide;
tpp Thiamin pyrophosphate;
x1p L-Xylulose 1-phosphate
xan Xanthine
xans Xanthosine
xmp Xanthosine 5′-phosphate
xu L-Xylulose
xu5p D-Xylulose 5-phosphate

### Abbreviation for the Reactions Described in the Minimal Networks

3HBTDH (S)-3-Hydroxybutanoyl-CoA:NADP+ oxidoreductase
3HBTDH (S)-3-Hydroxybutanoyl-CoA:NAD+ oxidoreductase
3HBTL (S)-3-hydroxybutanoyl-CoA hydro-lyase
3HPCH 3-Hydroxypropionyl-CoA hydrolase
3HPDH 3-hydroxypropionate:NADP+ oxidoreductase
3HXCT 3-hydroxybutyryl-CoA thiolase
3HXCTR 3-hydroxy-5-oxohexanoyl-CoA:acetate CoA-transferase
4HBTDH 4-hydroxybutanoate:NAD+ oxidoreductase
4HBTL 4-hydroxybutanoyl-CoA hydro-lyase
4HBTTR acetyl-CoA:4-hydroxybutanoate CoA-transferase
5MTHFRx 5-methyltetrahydrofolate:NAD+ oxidoreductase
5MTHFRy 5-methyltetrahydrofolate:ferredoxin oxidoreductase
ACALD acetaldehyde:NAD+ oxidoreductase (CoA-acetylating)
ACCOAC acetyl-coa carboxylase
ACDC acetyl-coA decathonylase
ACFTR Acetyl-CoA:formate C-acetyltransferase
ACK acetate kinase (hydroxylating)
ACK acetate kinate (ATP forming)
ACNDH acetoin dehydrogenase
ACONT Aconitase
ACS acetyl-coA synthase
ACTCH acetoacetyl-CoA hydrolase
ACTPP
ACTR Acetyl-CoA:acetyl-CoA C-acetyltransferase
AHSTR Acetyl-CoA:L-homoserine 0-acetyltransferase
AKGCL 2-Oxoglutarate carboxy-lyase
ALACDC 2-acetolactate decarboxylase
ALACL (S)-2-Acetolactate pyruvate-lyase (carboxylating)
ALCD acetaldehyde:NAD+ oxidoreductase (CoA-acetylating)
ALPYL 2-acetolactate pyruvate-lyase (carboxylating)
ASPL L-aspartate 1-carboxy-lyase (beta-alanine-forming)
ASPTA L-Aspartate:2-oxoglutamte aminotransferase
BDODH (R,R)-Butane-2,3-diol:NAD+ oxidoreductase
BTADH butanal:NAD+ oxidoreductase (CoA-acylating)
BTCM isobutyryl-coa mutase
BTDH butanoyl-CoA:NAD+ trans-2-oxidoreductase
BUTDH 1-butanol dehydrogenase
CO₂DH multi-step CO₂ folate reductase
CODH carbon-monoxide,water:ferredoxin oxidoreductase
CTCL (3 S)-citryl-CoA oxaloacetate-lyase (acetyl-CoA-forming)
CTCTR Acetyl-CoA:citrate CoA-transferase
DDT diol dehydratase
DPGLDH dihydrophloroglucinol:NADP+ oxidoreductase
DPGLH dihydrophloroglucinol hydrolase
ENO enolase
ETGLD 1,2-Ethanediol:NAD+ oxidoreductase
F6PA fructose 6-phosphate aldolase
FBA fructose-bisphosphate aldolase
FBP fructose-bisphosphatase
FDH formate dehydrogenase
FDNADPR Ferredoxin:NADP+ oxidoreductase
FDNADR Ferredoxin:NAD oxidoreductase
FEDH Fe2+:NAD+ oxidoreductase
FGLAH N-Formyl-L-glutamate amidohydrolase
FGLFT 5-Formiminotetrahydrofolate:L-glutamate N-formiminotransferase
FGLIH N-Formimino-L-glutamate iminohydrolase
FORD Formaldehyde:NAD+ oxidoreductase
FPK fructose-6-phosphate phosphoketolase
FTFAL 5-Formiminotetrahydrofolate ammonia-lyase (cyclizing)
FTHFH 10-Formyltetrahydrofolate amidohydrolase
FTKT formaldehyde transketolase
G3PD glycerol-3-phosphate dehydrogenase (NAD)
G3PD2 sn-glycerol-3-phosphate:NADP+1-oxidoreductase
G3PT glycerol-3-phosphatase
GABT GABA transaminase (ambiguous);
GAPD glyceraldehyde-3-phosphate dehydrogenase
GHMT glycine hydroxymethyltransferase, reversible
GLCL glycerol hydro-lyase (3-hydroxypropanal-forming)
GLCRDH D-Glycerate:NAD+2-oxidoreductase
GLCRK ATP:(R)-glycerate 2-phosphotransferase
GLUDH promiscuous glutamate dehydrogenase;
GLYCD glycerol:NAD+2-oxidoreductase
GLYCDx Glycerol dehydrogenase
GLYCHL Glycerol hydro-lyase
GLYCL glycine cleavage system
HBTDH (R)-3-Hydroxybutanoate:NAD+ oxidoreductase
HBUTDC 4-hydroxy-2-oxobutyrate decarboxylase
HDR heterodisulfide reductase
HEX1 hexokinase (D-glucose:ATP)
HMBL (R)-2,3-Dihydroxy-3-methylbutanoate hydro-lyase
HMBTDH (R)-2,3-dihydroxy-3-methylbutanoate:NADP+ oxidoreductase (isomerizing)
HPS hesulose-6-phosphate synthase
HSDH hydrogen-sulfide:NADP+ oxidoreductase
HXCOAT 3-hydroxy-5-oxohexanoyl-CoA thiolase
ICDH Isocitrate:NADP+ oxidoreductase (decarboxylating)
ICL Isocitrate Lyase
ICM iso-butyryl-Coa mutase
KIVDH 3-methyl-2-oxobutanoate:NAD+ oxidoreductase (CoA-mehtylpropanoylating)
KIVR 2-ketoisovalerate oxidoreductase
LA lactate aldolase
LACAT Lacatate acyl transferase
LACDH (S)-Lactate:NAD+ oxidoreductase
LACDR (S)-lactaldehyde:NAD+ oxidoreductase
LACDT Lactoyl-CoA dehydratase
MALCDH malonyl-CoA dehydrogenase
MALS malate synthase
MCL malyl-coa ligase
MCR CoM reductase
MDH malate dehydrogenase (NADP)
MDH malate dehydrogenase (NAD)
MEDH methanol dehydrogenase
MEDH methanol:NAD+ oxidoreductase
METR methanol:coenzyme M methyltransferase
MMALS 2-methyl malate synthase
MTA/MTBA [methyl-Co(III) corrinoid protein]:coenzyme M methyltransferase
MTHFH 5,10-Methenyltetrahydrofolate 5-hydrolase (decyclizing)
MTHFL 5,10-methylenetetrahydrofolate folmaldehyde lyase
MTHFR 5,10-methylenetetrahydrofolate:NAD+ oxidoreductase
MTK malate thiokinase
NH3DH ammonia:NAD+ oxidoreductase
NIFDH nitrite:ferredoxin oxidoreductase
PC pyruvate carboxylase
PDC pyruvate carboxy-lyase (acetaldehyde-forming)
PDODH propane-1,3-diol:NAD+1-oxidoreductase
PFOR pyruvate:ferredoxin 2-oxidoreductase (CoA-acetylating)
PGCD 3-Phospho-D-glycerate:NAD+2-oxidoreductase
PGI glucose-6-phosphate isomerase
PGK Phosphoglycerate kinase
PGLSa Phloroglucinol synthase a
PGLSb Phloroglucinol synthase b
PGM D-phosphoglycerate 2,3-phosphomutase
PHI 6-phospho-3-hexulo isomerase
PPC phosphoenolpyruvate carboxylase
PPS ATP:pyruvate,water phosphotransferase
PRPPS ATP:ribose-1,5-bisphosphate phosphotransferase
PSERT 3-Phosphoserine:2-oxoglutarate aminotransferase
PSP O-phospho-L-serine phosphohydrolase
R5PPT ATP:D-ribose-5-phosphate 1-phosphotransferase
RIBI D-ribose aldose-ketose-isomerase
RPE D-Ribulose-5-phosphate 3-epimerase
RPI D-ribose-5-phosphate aldose-ketose-isomerase
RUBK ATP:D-ribulose 5-phosphotransferase
S2O3 Da Thiosulfate:thiol sulfurtransferase
S2O3Db 3-Mercaptopyruvate:cyanide sulfurtransferase
SBPH Sedoheptulose 1,7-bisphosphate 1-phosphohydrolase
SBPL Sedoheptulose 1,7-bisphosphate D-glyceraldehyde-3-phosphate-lyase
SERAT L-Serine:glyoxylate aminotransferase
SUCADH succinate-semialdehyde:NADP+ oxidoreductase (CoA-acylating)
SUCTR succinyl-CoA:acetoacetate CoA-transferase
TALA transaldolase
THD NADP transhydrogenase
THFMT 5-methyltetrahydrofolate:corrinoid/iron-sulfur protein methyltransferase
TKT1 transketolase
TKT2 transketolase
TMFL Trimethylamine-N-oxide formaldehyde-lyase
TMMT trimethylamine methyltransferase
TMMT trimethylamine:coenzyme M methyltransferase
TMR NADH:trimethylamine-N-oxide oxidoreductase
TPI triose-phosphate isomerase
X1PL L-xylulose 1-phosphate glycolaldehyde-lyase (glycerone-phosphate-forming)
X1PT ATP:L-xylulose 1-phosphotransferase
X5PT ATP:D-xylulose 5-phosphotransferase
XANH Xanthosine ribohydrolase
XMPH xanthosine 5′-phosphate phosphohydrolase
XMPS XMP:pyrophosphate phosphoribosyltransferase
XPK xylulose-5-phosphate phosphoketolase

### REFERENCES

1. Cho C, Choi S Y, Luo Z W, Lee S Y (2014) Recent advances in microbial production of fuels and chemicals using tools and strategies of systems metabolic engineering. Biotechnol Adv.
2. Curran K A, Alper H S (2012) Expanding the chemical palate of cells by combining systems biology and metabolic engineering. Metab Eng 14: 289-297.
3. Liu L, Redden H, Alper H S (2013) Frontiers of yeast metabolic engineering: diversifying beyond ethanol and Saccharomyces. Curr Opin Biotechnol 24: 1023-1030.
4. Bonde M T, Kosuri S, Genee H J, Sarup-Lytzen K, Church G M, et al. (2014) Direct Mutagenesis of Thousands of Genomic Targets Using Microarray-Derived Oligonucleotides. ACS Synth Biol.
5. Sander J D, Joung J K (2014) CRISPR-Cas systems for editing, regulating and targeting genomes. Nat Biotechnol 32: 347-355.
6. Qi L S, Larson M H, Gilbert L A, Doudna J A, Weissman J S, et al. (2013) Repurposing CRISPR as an RNA-guided platform for sequence-specific control of gene expression. Cell 152: 1173-1183.
7. Na D, Yoo S M, Chung H, Park H, Park J H, et al. (2013) Metabolic engineering of Escherichia coli using synthetic small regulatory RNAs. Nat Biotechnol 31: 170-174.
8. Keasling J D (2010) Manufacturing molecules through metabolic engineering. Science 330: 1355-1358.
9. Zanghellini J, Ruckerbauer D E, Hanscho M, Jungreuthmayer C (2013) Elementary flux modes in a nutshell: properties, calculation and applications. Biotechnol J 8: 1009-1016.
10. Klamt S, Stelling J, Ginkel M, Gilles E D (2003) FluxAnalyzer: exploring structure, pathways, and flux distributions in metabolic networks on interactive flux maps. Bioinformatics 19: 261-269.
11. Pfeiffer T, Sanchez-Valdenebro I, Nuno J C, Montero F, Schuster S (1999) METATOOL: for studying metabolic networks. Bioinformatics 15: 251-257.
12. Trinh C T, Unrean P, Srienc F (2008) Minimal Escherichia coli cell for the most efficient production of ethanol from hexoses and pentoses. Appl Environ Microbiol 74: 3634-3643.
13. Ballerstein K, von Kamp A, Klamt S, Haus U U (2012) Minimal cut sets in a metabolic network are elementary modes in a dual network. Bioinformatics 28: 381-387.
14. Machado D, Soons Z, Patil K R, Ferreira E C, Rocha I (2012) Random sampling of elementary flux modes in large-scale metabolic networks. Bioinformatics 28: i515-i521.
15. Rezola A, de Figueiredo L F, Brock M, Pey J, Podhorski A, et al. (2011) Exploring metabolic pathways in genome-scale networks via generating flux modes. Bioinformatics 27: 534-540.
16. Bordbar A, Nagarajan H, Lewis N E, Latif H, Ebrahim A, et al. (2014) Minimal metabolic pathway structure is consistent with associated biomolecular interactions. Mol Syst Biol 10: 737.
17. Bar-Even A, Noor E, Lewis N E, Milo R (2010) Design and analysis of synthetic carbon fixation pathways. Proc Natl Acad Sci USA 107: 8889-8894.
18. Kim J, Reed J L, Maravelias C T (2011) Large-scale bi-level strain design approaches and mixed-integer programming solution techniques. PLoS One 6: e24162.
19. Pharkya P, Burgard A P, Maranas C D (2004) OptStrain: a computational framework for redesign of microbial production systems. Genome Res 14: 2367-2376.
20. Vieira G, Carnicer M, Portais J C, Heux S (2014) FindPath: a Matlab solution for in silico design of synthetic metabolic pathways. Bioinformatics 30: 2986-2988.
21. Jouhten P (2012) Metabolic modelling in the development of cell factories by synthetic biology. Comput Struct Biotechnol J 3: e201210009.
22. Deville Y, Gilbert D, van Helden J, Wodak S J (2003) An overview of data models for the analysis of biochemical pathways. Brief Bioinform 4: 246-259.
23. Rodrigo G, Carrera J, Prather K J, Jaramillo A (2008) DESHARKY: automatic design of metabolic pathways for optimal cell growth. Bioinformatics 24: 2554-2556.
24. McClymont K, Soyer O S (2013) Metabolic tinker: an online tool for guiding the design of synthetic metabolic pathways. Nucleic Acids Res 41: e113.
25. Faust K, Dupont P, Callut J, van Helden J (2010) Pathway discovery in metabolic networks by subgraph extraction. Bioinformatics 26: 1211-1218.
26. Wu D, Wang Q, Assary R S, Broadbelt L J, Krilov G (2011) A computational approach to design and evaluate enzymatic reaction pathways: application to 1-butanol production from pyruvate. J Chem Inf Model 51: 1634-1647.
27. Carbonell P, Parutto P, Herisson J, Pandit S B, Faulon J L (2014) XTMS: pathway design in an eXTended metabolic space. Nucleic Acids Res 42: W389-394.
28. Campodonico M A, Andrews B A, Asenjo J A, Palsson B O, Feist A M (2014) Generation of an atlas for commodity chemical production in Escherichia coli and a novel pathway prediction algorithm, GEM-Path. Metab Eng 25: 140-158.
29. Moura M, Broadbelt L, Tyo K (2013) Computational tools for guided discovery and engineering of metabolic pathways. Methods Mol Biol 985: 123-147.
30. Bogorad I W, Lin T S, Liao J C (2013) Synthetic non-oxidative glycolysis enables complete carbon conservation. Nature 502: 693-697.
31. Atsumi S, Cann A F, Connor M R, Shen C R, Smith K M, et al. (2008) Metabolic engineering of Escherichia coli for 1-butanol production. Metab Eng 10: 305-311.
32. Bogorad I W, Chen C T, Theisen M K, Wu T Y, Schlenz A R, et al. (2014) Building carbon-carbon bonds using a biocatalytic methanol condensation cycle. Proc Natl Acad Sci USA 111: 15928-15933.
33. Borodina I, Kildegaard K R, Jensen N B, Blicher T H, Maury J, et al. (2015) Establishing a synthetic pathway for high-level production of 3-hydroxypropionic acid in Saccharomyces cerevisiae via beta-alanine. Metab Eng 27: 57-64.
34. Kopke M, Mihalcea C, Liew F, Tizard J H, Ali M S, et al. (2011) 2,3-butanediol production by acetogenic bacteria, an alternative route to chemical synthesis, using industrial waste gas. Appl Environ Microbiol 77: 5467-5475.
35. Kumar A, Suthers P F, Maranas C D (2012) MetRxn: a knowledgebase of metabolites and reactions spanning metabolic models and databases. BMC Bioinformatics 13: 6.
36. MarvinSketch (2015) Online Chemical Editor (MarvinSketch)—Draw Molecules and Reactions Online.
37. Aziz R K, Devoid S, Disz T, Edwards R A, Henry C S, et al. (2012) SEED servers: high-performance access to the SEED genomes, annotations, and metabolic models. PLoS One 7: e48053.
38. Haveren J V, Scott E L, Sanders J (2008) Bilk chemicals from biomass. Biofuels, Bioproducts and Biorefining 2: 41-57.
39. Bennett B D, Kimball E H, Gao M, Osterhout R, Van Dien S J, et al. (2009) Absolute metabolite concentrations and implied enzyme active site occupancy in Escherichia coli. Nat Chem Biol 5: 593-599.
40. Lewis N E, Hixson K K, Conrad T M, Lerman J A, Charusanti P, et al. (2010) Omic data from evolved E. coli are consistent with computed optimal growth from genome-scale models. Mol Syst Biol 6: 390.
41. Lee S, Phalakornkule C, Domach M M, Grossmann I E (2000) Recursive MILP model for finding all the alternate optima in LP models for metabolic networks. Computers & Chemical Engineering 24: 711-716.
42. Ignizio J P, Cavalier T M (1994) Linear programming: Prentice-Hall, Inc.
43. Flamholz A, Noor E, Bar-Even A, Liebermeister W, Milo R (2013) Glycolytic strategy as a tradeoff between energy yield and protein cost. Proc Natl Acad Sci USA 110: 10039-10044.
44. Verhees C H, Kengen S W, Tuininga J E, Schut G J, Adams M W, et al. (2003) The unique features of glycolytic pathways in Archaea. Biochem J 375: 231-246.
45. Aristilde L, Lewis I A, Park J O, Rabinowitz J D (2014) Hierarchy in Pentose Sugar Metabolism in Clostridium Acetobutylicum. Appl Environ Microbiol.
46. O'Donnell M M, O'Toole P W, Ross R P (2013) Catabolic flexibility of mammalian-associated lactobacilli. Microb Cell Fact 12: 48.
47. Wiegant W M, Debont J A M (1980) A New Route for Ethylene-Glycol Metabolism in Mycobacterium-E44. Journal of General Microbiology 120: 325-331.
48. Gawand P, Hyland P, KEknis A, Martin V J J, Mahadevan R (2013) Novel approach to engineer strains for simultaneous sugar utilization. Metabolic Engineering 20: 63-72.
49. Tracy B P, Jones S W, Fast A G, Indurthi D C, Papoutsakis E T (2012) Clostridia: the importance of their exceptional substrate and metabolite diversity for biofuel and biorefinery applications. Curr Opin Biotechnol 23: 364-381.
50. Huang H, Wang S, Moll J, Thauer R K (2012) Electron bifurcation involved in the energy metabolism of the acetogenic bacterium Moorella thermoacetica growing on glucose or H2 plus CO₂. J Bacteriol 194: 3689-3699.
51. Ragsdale S W (2003) Pyruvate ferredoxin oxidoreductase and its radical intermediate. Chem Rev 103: 2333-2346.
52. Jang Y S, Kim B, Shin J H, Choi Y J, Choi S, et al. (2012) Bio-based production of C2-C6 platform chemicals. Biotechnol Bioeng 109: 2437-2459.
53. Singh I P, Sidana J, Bansal P, Foley W J (2009) Phloroglucinol compounds of therapeutic interest: global patent and technology status. Expert Opin Ther Pat 19: 847-866.
54. Wang L, Chen H, Zhang T, Zhang J, Yang L (2007) Synthesis, characterization, thermal and explosive properties of potassium salts of trinitrophloroglucinol. J Hazard Mater 147: 576-580.
55. Kolb S, Stacheter A (2013) Prerequisites for amplicon pyrosequencing of microbial methanol utilizers in the environment. Front Microbiol 4: 268.
56. Pritchett M A, Metcalf W W (2005) Genetic, physiological and biochemical characterization of multiple methanol methyltransferase isozymes in Methanosarcina acetivorans C2A. Mol Microbiol 56: 1183-1194.
57. Doukov T I, Iverson T M, Seravalli J, Ragsdale S W, Drennan C L (2002) A Ni—Fe—Cu center in a bifunctional carbon monoxide dehydrogenase/acetyl-CoA synthase. Science 298: 567-572.
58. Kato N, Yurimoto H, Thauer R K (2006) The physiological role of the ribulose monophosphate pathway in bacteria and archaea. Biosci Biotechnol Biochem 70: 10-21.
59. Bender R A (2012) Regulation of the histidine utilization (hut) system in bacteria. Microbiol Mol Biol Rev 76: 565-584.
60. Alissandratos A, Kim H K, Easton C J (2013) Formate production through biocatalysis. Bioengineered 4: 348-350.
61. Krainer F W, Dietzsch C, Hajek T, Herwig C, Spadiut O, et al. (2012) Recombinant protein expression in Pichia pastoris strains with an engineered methanol utilization pathway. Microb Cell Fact 11: 22.
62. Mainguet S E, Gronenberg L S, Wong S S, Liao J C (2013) A reverse glyoxylate shunt to build a non-native route from C4 to C2 in Escherichia coli. Metab Eng 19: 116-127.
63. Yang J, Wang Z, Zhu N, Wang B, Chen T, et al. (2014) Metabolic engineering of Escherichia coli and in silico comparing of carboxylation pathways for high succinate productivity under aerobic conditions. Microbiol Res 169: 432-440.
64. Heinrich D, Raberg M, Steinbuchel A (2015) Synthesis of poly(3-hydroxybutyrate-co-3-hydroxyvalerate) from unrelated carbon sources in engineered Rhodospirillum rubrum. FEMS Microbiol Lett.
65. Zhang J, Gao X, Hong P H, Li Z J, Tan T W (2015) Enhanced production of poly-3-hydroxybutyrate by Escherichia coli over-expressing multiple copies of NAD kinase integrated in the host genome. Biotechnol Lett.
66. Buchholz J, Schwentner A, Brunnenkan B, Gabris C, Grimm S, et al. (2013) Platform engineering of Corynebacterium glutamicum with reduced pyruvate dehydrogenase complex activity for improved production of L-lysine, L-valine, and 2-ketoisovalerate. Appl Environ Microbiol 79: 5566-5575.
67. Cracan V, Banerjee R (2012) Novel coenzyme B12-dependent interconversion of isovaleryl-CoA and pivalyl-CoA. J Biol Chem 287: 3723-3732.
68. Cao Y, Jiang X, Zhang R, Xian M (2011) Improved phloroglucinol production by metabolically engineered Escherichia coli. Appl Microbiol Biotechnol 91: 1545-1552.
69. Blum T, Kohlbacher 0 (2008) MetaRoute: fast search for relevant metabolic routes for interactive network navigation and visualization. Bioinformatics 24: 2108-2109.
70. Hatzimanikatis V, Li C, Ionita J A, Henry C S, Jankowski M D, et al. (2005) Exploring the diversity of complex metabolic networks. Bioinformatics 21: 1603-1609.
71. EIA U (2013) Technically Recoverable Shale Oil and Shale Gas Resources: An Assessment of 137 Shale Formations in 41 Countries Outside the United States. In: US Department of Energy/EIA W, DC, editor.
72. Haynes C A, Gonzalez R (2014) Rethinking biological activation of methane and conversion to liquid fuels. Nat Chem Biol 10: 331-339.
73. Cui M, Ma A, Qi H, Zhuang X, Zhuang G (2015) Anaerobic oxidation of methane: an “active” microbial process. Microbiologyopen 4: 1-11.
74. Mueller T J, Grisewood M J, Nazem-Bokaee H, Gopalakrishnan S, Ferry J G, et al. (2015) Methane oxidation by anaerobic archaea for conversion to liquid fuels. J Ind Microbiol Biotechnol 42: 391-401.
75. de Jong E, Higson A, Walsh P, Wellisch M (2012) Bio-based chemicals value added products from biorefineries. IEA Bioenergy, Task42 Biorefinery.
76. Conrado R J, Gonzalez R (2014) Chemistry. Envisioning the bioconversion of methane to liquid fuels. Science 343: 621-623.
77. Orphan V J, Hinrichs K U, Ussler W, 3rd, Paull C K, Taylor L T, et al. (2001) Comparative analysis of methane-oxidizing archaea and sulfate-reducing bacteria in anoxic marine sediments. Appl Environ Microbiol 67: 1922-1934.
78. Valentine D L (2002) Biogeochemistry and microbial ecology of methane oxidation in anoxic environments: a review. Antonie Van Leeuwenhoek 81: 271-282.
79. Mazoch J, Tesarik R, Sedlacek V, Kucera I, Turanek J (2004) Isolation and biochemical characterization of two soluble iron(III) reductases from Paracoccus denitrificans. Eur J Biochem 271: 553-562.
80. Jackson R H, Cornish-Bowden A, Cole J A (1981) Prosthetic groups of the NADH-dependent nitrite reductase from Escherichia coli K12. Biochem J 193: 861-867.
81. Murphy M J, Siegel L M, Kamin H (1974) Reduced nicotinamide adenine dinucleotide phosphate-sulfite reductase of enterobacteria. V I. The reaction of carbon monoxide with the Escherichia coli holoenzyme, the hemoprotein, and free siroheme. J Biol Chem 249: 1610-1614.
82. Lucker S, Nowka B, Rattei T, Spieck E, Daims H (2013) The Genome of Nitrospina gracilis Illuminates the Metabolism and Evolution of the Major Marine Nitrite Oxidizer. Front Microbiol 4: 27.
83. Setya A, Murillo M, Leustek T (1996) Sulfate reduction in higher plants: molecular evidence for a novel 5′-adenylylsulfate reductase. Proc Natl Acad Sci USA 93: 13383-13388.
84. Vachek H, Wood J L (1972) Purification and properties of mercaptopyruvate sulfur transferase of Escherichia coli. Biochim Biophys Acta 258: 133-146.
85. Alberty R A (1998) Calculation of standard transformed formation properties of biochemical reactants and standard apparent reduction potentials of half reactions. Arch Biochem Biophys 358: 25-39.
86. Petitdemange H, Cherrier C, Raval R, Gay R (1976) Regulation of the NADH and NADPH-ferredoxin oxidoreductases in clostridia of the butyric group. Biochim Biophys Acta 421: 334-337.
87. Bose A, Pritchett M A, Metcalf W W (2008) Genetic analysis of the methanol- and methylamine-specific methyltransferase 2 genes of Methanosarcina acetivorans C2A. J Bacteriol 190: 4017-4026.
88. Paul L, Ferguson D J, Jr., Krzycki J A (2000) The trimethylamine methyltransferase gene and multiple dimethylamine methyltransferase genes of Methanosarcina barkeri contain in-frame and read-through amber codons. J Bacteriol 182: 2520-2529.
89. Xiao Z, Lu J R (2014) Strategies for enhancing fermentative production of acetoin: a review. Biotechnol Adv 32: 492-503.
90. Kopke M, Gerth M L, Maddock D J, Mueller A P, Liew F, et al. (2014) Reconstruction of an acetogenic 2,3-butanediol pathway involving a novel NADPH-dependent primary-secondary alcohol dehydrogenase. Appl Environ Microbiol 80: 3394-3403.
91. Carballo J, Martin R, Bernardo A, Gonzalez J (1991) Purification, characterization and some properties of diacetyl(acetoin) reductase from Enterobacter aerogenes. Eur J Biochem 198: 327-332.
92. Honjo H, Tsuruno K, Tatsuke T, Sato M, Hanai T (2015) Dual synthetic pathway for 3-hydroxypropionic acid production in engineered Escherichia coli. J Biosci Bioeng.
93. Rathnasingh C, Raj S M, Lee Y, Catherine C, Ashok S, et al. (2012) Production of 3-hydroxypropionic acid via malonyl-CoA pathway using recombinant Escherichia coli strains. J Biotechnol 157: 633-640.
94. Dellomonaco C, Clomburg J M, Miller E N, Gonzalez R (2011) Engineered reversal of the beta-oxidation cycle for the synthesis of fuels and chemicals. Nature 476: 355-359.
95. Lim J H, Seo S W, Kim S Y, Jung G Y (2013) Model-driven rebalancing of the intracellular redox state for optimization of a heterologous n-butanol pathway in Escherichia coli. Metab Eng 20: 56-62.
96. Xiong W, Brune D, Vermaas W F (2014) The gamma-aminobutyric acid shunt contributes to closing the tricarboxylic acid cycle in Synechocystis sp. PCC 6803. Mol Microbiol 93: 786-796.
97. Leja K, Samul D, Drozdzynska A, Myszka K, Juzwa W, et al. (2014) Hypothetical glycerol pathways of newly isolated strains capable of 1,3-propanediol production. Acta Biochim Pol 61: 759-763.
98. Emptage M, Haynie S L, Laffend L A, Pucci J P, Whited G (1997) Genetically engineered Escherichia coli containing nonspecific dehydratase yghD and dha regulon for the biological production of 1, 3-propanediol with high titer. US patent.
99. Celinska E (2014) Fully glycerol-independent microbial production of 1, 3-propanediol via non-natural pathway: Paving the way to success with synthetic tiles. Biotechnol J.
100. Kanehisa M, Goto S, Sato Y, Kawashima M, Furumichi M, et al. (2014) Data, information, knowledge and principle: back to metabolism in KEGG. Nucleic Acids Res 42: D199-205.
101. Schomburg I, Chang A, Ebeling C, Gremse M, Heldt C, et al. (2004) BRENDA, the enzyme database: updates and major new developments. Nucleic Acids Res 32: D431-433.
102. Barron M G, Lilavois C R, Martin T M (2015) MOAtox: A comprehensive mode of action and acute aquatic toxicity database for predictive model development. Aquat Toxicol 161C: 102-107.

What is claimed is:

1. A method of designing de novo metabolic networks, said method comprising:
a. providing one or more source metabolites and one or more target products;
b. selecting one or more reaction constraints to define and/or optimize the overall stoichiometry of the conversion;
c. determining the overall stoichiometry of the conversion for converting the one or more source metabolites to the one or more target products;
d. optimizing the overall stoichiometry of the conversion by exhaustively exploring co-reactant/co-product combinations and their respective stoichiometric coefficients;
e. accessing a database of metabolites, said database containing specific data for each metabolite;
f. identifying an optimal network of intervening metabolites and reactions from the database that link the provided one or more source metabolites and the one more target products in the desired stoichiometric ratios.

2. The method of claim 1, wherein the step of optimizing the overall stoichiometry of the conversion for a desired metabolic conversion includes solving an optimization problem.

3. The method of claim 2, wherein the optimization problem to determine the overall stoichiometry of the conversion ensures that the overall stoichiometry is mass and charge balanced, and thermodynamically feasible.

4. The method of claim 2, wherein the optimization problem to determine the overall stoichiometry of the conversion allows the identification of additional co-reactants/co-products in the overall reaction not fixed a priori and accessed from the database of metabolites.

5. The method of claim 2, wherein the optimization problem to determine the overall stoichiometry of the conversion includes alternate profit margin considerations to ensure market price of the provided one or more target products exceed the one or more source metabolites costs by a pre-specified margin.

6. The computational method claim in 2 wherein the optimization problem to determine the overall stoichiometry directly includes trade-offs with biomass, growth and non-growth associated maintenance ATP as additional product metabolites.

7. The method of claim 1, wherein the step of the smallest network of reactions that apportions the elemental composition of the substrates to the desired target products in their corresponding stoichiometric ratios as determined in claim 2 includes solving an optimization problem.

8. The method of claim 7, wherein the step of identifying the optimal network is optimized to determine the smallest network minimizes the total number of reactions in the reaction while maintaining stoichiometric balance and fixed limits on the exchange of source metabolites and target products.

9. The method of claim 7, wherein the step of identifying the optimal network is optimized to determine the smallest network minimizes the total metabolic fluxes of the network while maintaining stoichiometric balance and fixed limits on the exchange of source metabolites and target products.

10. The method of claim 1, wherein the step of identifying the optimal network further comprises identifying alternate optimal and suboptimal networks that satisfy the overall stoichiometry.

11. The method of claim 7, wherein the step of identifying the optimal network is optimized to determine the smallest network includes additional provision of maintaining the total number of reactions with a positive standard free energy of change at a minimum

12. The method of claim 7, wherein the step of identifying the optimal network is optimized to determine the smallest network includes additional provision of minimizing the number of organisms from which reactions are sourced in the construction of the conversion network

13. The method of claim 1, wherein the step of identifying the optimal network is optimized to construct at least six networks for metabolic conversion of glucose to acetate with 100% carbon efficiency.

14. The method of claim 13, wherein the step of identifying the optimal network is optimized to construct networks for conversion of glucose to acetate included network with maximum energy efficiency of three ATP per molecule of glucose converted

15. The method of claim 13, wherein the step of identifying the optimal network is optimized to construct networks for 100% conversion of glucose to acetate included network with no nonnative reactions.

16. The method of claim 13, wherein the step of identifying the optimal network is optimized to construct networks for 100% conversion of glucose to acetate included network with no phosphoketolase reactions or CO₂ production.

17. The method of claim 13, wherein the step of identifying the optimal network is optimized to construct networks for 100% conversion of glucose to acetate included network with minimal reactions with positive standard Gibbs energy change.

18. The method of claim 1, wherein the step of identifying the optimal network is optimized to design exhaustive list of overall stoichiometries for maximizing the conversion of methanol and carbon dioxide to feasible C2+ metabolites.

19. The method of claim 18, wherein the step of identifying the optimal network is optimized for conversion of methanol and carbon dioxide to feasible C2+ metabolites implemented to construct at least three networks for production of acetate.

20. The method of claim 19, wherein the step of identifying the optimal network is optimized to construct minimal networks for conversion of methanol and carbon dioxide to acetate include network requiring the minimum number of reactions.

21. The method of claim 19, wherein the step of identifying the optimal network is optimized to construct minimal networks for conversion of methanol and carbon dioxide to acetate include network with no oxygen sensitive reactions.

22. The method of claim 19, wherein the step of identifying the optimal network is optimized to construct minimal networks for conversion of methanol and carbon dioxide to acetate include network with all reactions native or previously expressed in E. coli.

23. The method of claim 18, wherein the step of identifying the optimal network is optimized for conversion of methanol and carbon dioxide to feasible C2+ metabolites implemented to construct at least one network for production of 3-hydroxyvalerate, 2-ketoisovalerate and phloroglucinol.

24. The method of claim 1, wherein the step of identifying the optimal network is configured to identify, rank, and determine the overall stoichiometry of an exhaustive list of electron pair acceptors for thermodynamically feasible conversion of methane to acetate.

25. The method of claim 24, wherein the step of identifying the optimal network is configured to design overall stoichiometries of electron pair acceptors for thermodynamically feasible conversion of methane to acetate implemented to construct at least three metabolic networks for the conversion of methane and CO2 to acetate driven be iron (III)/iron (II) electron pair.

26. The method of claim 24, wherein the step of identifying the optimal network is configured to design overall stoichiometries of electron pair acceptors for thermodynamically feasible conversion of methane to acetate implemented to construct at least three metabolic networks for the conversion of methane and CO2 to 3-hyfroxypropionate driven be nitrite/ammonium electron pair.

27. The method of claim 24, wherein the step of identifying the optimal network is configured to design overall stoichiometries of electron pair acceptors for thermodynamically feasible conversion of methane to acetate implemented to construct at least two metabolic networks for the conversion of methane and CO2 to 2,3-butanediol driven be nitrate/nitrite electron pair.

28. The method of claim 24, wherein the step of identifying the optimal network is configured to design overall stoichiometries of electron pair acceptors for thermodynamically feasible conversion of methane to acetate implemented to construct at least two metabolic networks for the conversion of methane and CO2 to 1-butanol driven be sulfite/thiosulfate electron pair.

29. The method of claim 24, wherein the step of identifying the optimal network is configured to design overall stoichiometries of electron pair acceptors for thermodynamically feasible conversion of methane to acetate implemented to construct at least two metabolic networks for the conversion of methane and CO2 to 1,3-propanediol driven be sulfite/hydrogen sulfide electron pair.

30. A computational method of designing de novo metabolic networks comprising steps of:
a. determining an overall stoichiometry of the conversion for converting source metabolite(s) to target product(s) by exhaustively exploring co-reactant/co-product combinations and their respective stoichiometric coefficients using a suitably programmed computing device; and
b. identifying an optimal network of intervening metabolites and reactions from a database that link chosen reactants and products in desired stoichiometric ratios using the computing device.

31. A modified organism comprising the optimal network of intervening metabolites and reactions identified using the method of claim 30.

32. A system for designing de novo metabolic networks comprising:
a computing device;
a set of instructions executing on the computing device, the set of instructions performing a method comprising (a) determining an overall stoichiometry of the conversion for converting source metabolite(s) to target product(s) by exhaustively exploring co-reactant/co-product combinations and their respective stoichiometric coefficients and (b) identifying an optimal network of intervening metabolites and reactions from a database that link chosen reactants and products in desired stoichiometric ratios.
